(19) United States
(12) Patent Application Publication
(10) Pub. No.: US 2022/0039416 A1
(43) Pub. Date: Feb. 10, 2022

(54) METHODS OF CONTROLLING THE RIPENING OF AGRICULTURAL PRODUCTS

(71) Applicant: Apeel Technology, Inc., Goleta, CA (US)

(72) Inventors: Stephen William Kaun, Santa Barbara, CA (US); Amy Louise Keech, Goleta, CA (US); Charles Patrick Frazier, Goleta, CA (US)

(21) Appl. No.: 17/394,035

(22) Filed: Aug. 4, 2021

Related U.S. Application Data
(60) Provisional application No. 63/061,150, filed on Aug. 4, 2020.

(51) Int. Cl. A23B 7/16; A23B 7/154; A23B 7/152

(52) U.S. Cl. CPC A23B 7/16; A23V 2002/00; A23B 7/152; A23B 7/154

(57) ABSTRACT

Modulating the ripening of an underripe produce unit at a temperature includes treating the underripe produce unit with a chemical treatment, a physical treatment, or both. The underripe produce unit has a first respiration rate determined at the temperature at a first time and a second respiration rate determined at the temperature at a second time. The first time and the second time are different. The second respiration rate is at least about 10% greater than the first respiration rate at the temperature.

### CROSS-REFERENCE TO RELATED APPLICATION

This application claims the benefit of U.S. Application No. 63/061,150 entitled “METHODS OF CONTROLLING THE RIPENING OF AGRICULTURAL PRODUCTS” and filed on Aug. 4, 2020, which is incorporated herein by reference in its entirety.

### BACKGROUND

Many common agricultural products, for example avocados and bananas, are typically harvested prior to complete ripening and then allowed to fully ripen post-harvest, for example during storage or shipping. Since many of these products are seasonal, and hence only ripen during a limited time window, it may be desirable to delay the ripening of the produce in order to increase the effective shelf life of the produce and/or to make the produce available to consumers during times that they would not otherwise be available.

### SUMMARY

Provided herein is a method for modulating the ripening of an underripe produce unit at a temperature, the method including (a) determining a first respiration rate for the underripe produce unit at the temperature, (b) determining a second respiration rate for the underripe produce unit at the temperature, wherein the second respiration rate can be at least about 10% greater than the first respiration rate, and (c) treating the underripe produce unit with a chemical treatment, a physical treatment, or both.

In some embodiments, determining the first respiration rate can be performed at least 24 hours after the underripe produce unit can be harvested. In some embodiments, determining the first respiration rate can be performed at least 48 hours after the underripe produce unit can be harvested. In some embodiments, determining the first respiration rate can be performed at least 4 days after the underripe produce unit can be harvested. In some embodiments, determining the first respiration rate can be performed at least 1 week after the underripe produce unit can be harvested. In some embodiments, determining the first respiration rate can be performed at least 2 weeks after the underripe produce unit can be harvested.

In some embodiments, determining the first respiration rate can be performed less than 3 weeks after the underripe produce unit can be harvested. In some embodiments, determining the first respiration rate can be performed less than 2 weeks after the underripe produce unit can be harvested. In some embodiments, determining the first respiration rate can be performed less than 1 week after the underripe produce unit can be harvested. In some embodiments, determining the first respiration rate can be performed less than 4 days after the underripe produce unit can be harvested. In some embodiments, determining the first respiration rate can be performed less than 48 hours after the underripe produce unit can be harvested.

In some embodiments, determining the second respiration rate can be performed at least 24 hours after determining the first respiration rate. In some embodiments, determining the second respiration rate can be performed at least 48 hours after determining the first respiration rate. In some embodiments, determining the second respiration rate can be performed at least 4 days after determining the first respiration rate. In some embodiments, determining the second respiration rate can be performed at least 1 week after determining the first respiration rate. In some embodiments, determining the second respiration rate can be performed at least 2 weeks after determining the first respiration rate.

In some embodiments, determining the second respiration rate can be performed less than 3 weeks after determining the first respiration rate. In some embodiments, determining the second respiration rate can be performed less than 2 weeks after determining the first respiration rate. In some embodiments, determining the second respiration rate can be performed less than 1 week after determining the first respiration rate. In some embodiments, determining the second respiration rate can be performed less than 4 days after determining the first respiration rate. In some embodiments, determining the second respiration rate can be performed less than 48 hours after determining the first respiration rate.

In some embodiments, the first respiration rate can be a baseline respiration rate for the underripe produce unit at the temperature.

In some embodiments, the first respiration rate can be a transient respiration rate for the underripe produce unit at the temperature.

In some embodiments, the second respiration rate can be at least 15% greater than the first respiration rate. In some embodiments, the second respiration rate can be at least 20% greater than the first respiration rate. In some embodiments, the second respiration rate can be at least 30% greater than the first respiration rate.

In some embodiments, the second respiration rate can be about 10% to about 15% greater than the first respiration rate. In some embodiments, the second respiration rate can be about 10% to about 20% greater than the first respiration rate. In some embodiments, the second respiration rate can be about 10% to about 30% greater than the first respiration rate.

In another aspect, provided herein is a method for modulating the ripening of an underripe produce unit at a temperature, the method including treating the underripe produce unit determined to have a second respiration rate of at least about 10% greater than a first respiration rate for the produce unit at the temperature with a chemical treatment, a physical treatment, or both.

In some embodiments, determination of the first respiration rate was performed at least 24 hours after the underripe produce unit was harvested. In some embodiments, determination of the first respiration rate was performed at least 48 hours after the underripe produce unit was harvested. In some embodiments, determination of the first respiration rate was performed at least 4 days after the underripe produce unit was harvested. In some embodiments, determination of the first respiration rate was performed at least 1 week after the underripe produce unit was harvested. In some embodiments, determination of the first respiration rate was performed at least 2 weeks after the underripe produce unit was harvested.

In some embodiments, determination of the first respiration rate was performed less than 3 weeks after the underripe produce unit was harvested. In some embodiments, determination of the first respiration rate was performed less than 2 weeks after the underripe produce unit was harvested. In some embodiments, determination of the first respiration rate was performed less than 1 week after the underripe produce unit was harvested. In some embodiments, determination of the first respiration rate was performed less than 4 days after the underripe produce unit was harvested. In some embodiments, determination of the first respiration rate was performed less than 48 hours after the underripe produce unit was harvested.

In some embodiments, determination of the second respiration rate was performed at least 24 hours after determination of the first respiration rate. In some embodiments, determination of the second respiration rate was performed at least 48 hours after determination of the first respiration rate. In some embodiments, determination of the second respiration rate was performed at least 4 days after determination of the first respiration rate. In some embodiments, determination of the second respiration rate was performed at least 1 week after determination of the first respiration rate. In some embodiments, determination of the second respiration rate was performed at least 2 weeks after determination of the first respiration rate.

In some embodiments, determination of the second respiration rate was performed less than 3 weeks after determination of the first respiration rate. In some embodiments, determination of the second respiration rate was performed less than 2 weeks after determination of the first respiration rate. In some embodiments, determination of the second respiration rate was performed less than 1 week after determination of the first respiration rate. In some embodiments, determination of the second respiration rate was performed less than 4 days after determination of the first respiration rate. In some embodiments, determination of the second respiration rate was performed less than 48 hours after determination of the first respiration rate.

In some embodiments, the first respiration rate can be a baseline respiration rate for the underripe produce unit at the temperature.

In some embodiments, the first respiration rate can be a transient respiration rate for the underripe produce unit at the temperature.

In some embodiments, the second respiration rate can be at least 15% greater than the first respiration rate. In some embodiments, the second respiration rate can be at least 20% greater than the first respiration rate. In some embodiments, the second respiration rate can be at least 30% greater than the first respiration rate.

In some embodiments, the second respiration rate can be about 10% to about 15% greater than the first respiration rate. In some embodiments, the second respiration rate can be about 10% to about 20% greater than the first respiration rate. In some embodiments, the second respiration rate can be about 10% to about 30% greater than the first respiration rate.

In some embodiments, modulating the ripening of the underripe produce unit includes extending a duration of time in which the underripe produce unit can be underripe. In some embodiments, modulating the ripening of the underripe produce unit includes increasing the total number of days that the underripe produce unit can be in stage 1 or stage 2. In some embodiments, modulating the ripening of the underripe produce unit includes extending a duration of time that the underripe produce unit can be acceptably ripe. In some embodiments, modulating the ripening of the underripe produce unit includes increasing the total number of days that the produce unit can be in stage 3, stage 4, or stage 5. In some embodiments, modulating the ripening of the underripe produce unit includes extending a shelf life of the produce unit. In some embodiments, modulating the ripening of the underripe produce unit includes increasing the total number of days that the produce unit can be in stage 1, stage 2, stage 3, stage 4, or stage 5. In some embodiments, modulating the ripening of the underripe produce unit includes delaying a senescent response, decreasing the intensity of a senescent response, or both. In some embodiments, the senescent response can be selected from the group consisting of a color change, softening, starch metabolism, mass loss, wrinkling, a fibrous appearance, and a combination thereof. In some embodiments, a color change includes browning, yellowing, blackening, or a combination thereof. In some embodiments, modulating the ripening of the underripe produce unit includes decreasing susceptibility of the underripe produce unit to a biological stressor associated with produce spoilage. In some embodiments, the biological stressor associated with produce spoilage can be selected from the group consisting of fungi, bacteria, and a combination thereof. In some embodiments, the fungi can be selected from the group consisting of mold, yeast, and a combination thereof.

In some embodiments, the underripe produce unit can be a climacteric produce unit. In some embodiments, the climacteric produce unit can be selected from the group consisting of an apple, an apricot, an avocado, a banana, a blueberry, a bayberry, a custard apple, a fig, a guava, a kiwifruit, a lychee, a mamey sapote, a mango, a melon, a mountain papaya, a nectarine, a papaya, a peach, a pear, a persimmon, a plum, a tomato, and a combination thereof.

In some embodiments, the underripe produce unit can be a non-climacteric produce unit. In some embodiments, the non-climacteric produce unit can be selected from the group consisting of a cherry, a clementine mandarin, a cucumber, a grape, a grapefruit, a lime, an orange, a pepper, a pineapple, a strawberry, a watermelon, and a combination thereof.

In some embodiments, the underripe produce unit can be an avocado. In some embodiments, modulating the ripening of the avocado includes increasing the total number of days that the avocado can be in stage 1 or stage 2. In some embodiments, modulating the ripening of the avocado includes increasing the total number of days that the avocado can be in stage 3, stage 4, or stage 5.

In some embodiments, chemical treatment includes an inhibitor of an ethylene receptor. In some embodiments, the inhibitor of the ethylene receptor can be selected from the group consisting of diazocyclopentadiene (DACP), cyclopropene (CP), 1-methylcyclopropene (1-MCP), 3,3-dimethylcyclopropene (3,3-DMCP), and a combination thereof. In some embodiments, the inhibitor of the ethylene receptor can be 1-MCP. In some embodiments, the temperature can be above the boiling point of the inhibitor of the ethylene receptor. In some embodiments, the temperature can be below the boiling point of the inhibitor of the ethylene receptor. In some embodiments, the underripe produce unit can be contained in a volume (in liters), and treating with the chemical treatment includes applying the chemical treatment in an amount of about 0.01 mg/liter volume to about 0.1 mg/liter volume. In some embodiments, treating with the chemical treatment includes applying the chemical treatment in an amount of about 0.01 mg/liter volume to about 0.03 mg/liter volume. In some embodiments, treating with the chemical treatment includes applying the chemical treatment in an amount of about 0.02 mg/liter volume to about 0.07 mg/liter volume. In some embodiments, treating with the chemical treatment includes exposing the underripe produce unit to the chemical treatment for a period of about 1 hour to about 24 hours. In some embodiments, treating with the chemical treatment includes exposing the underripe produce unit to the chemical treatment for a period of about 6 hours to about 18 hours. In some embodiments, treating with the chemical treatment includes exposing the underripe produce unit to the chemical treatment for a period of about 6 hours to about 12 hours.

In some embodiments, the physical treatment includes a coating. In some embodiments, the physical treatment includes a monoglyceride and a fatty acid salt. In some embodiments, the monoglyceride can be present in the physical treatment in an amount of about 50% to about 99% by mass. In some embodiments, the monoglyceride can be present in the physical treatment in an amount of about 90% to about 99% by mass. In some embodiments, the monoglyceride can be present in the physical treatment in an amount of about 95% by mass. In some embodiments, the monoglyceride includes monoglycerides having carbon chain lengths longer than or equal to 10 carbons (e.g., longer than 11, longer than 12, longer than 14, longer than 16, longer than 18). In some embodiments, the monoglyceride includes monoglycerides having carbon chain lengths shorter than or equal to 20 carbons (e.g., shorter than 18, shorter than 16, shorter than 14, shorter than 12, shorter than 11, shorter than 10). In some embodiments, the monoglyceride includes a C16 monoglyceride and a C18 monoglyceride. In some embodiments, the fatty acid salt can be present in the physical treatment in an amount of about 1% to about 50% by mass. In some embodiments, the fatty acid salt can be present in the physical treatment in an amount of about 1% to about 10% by mass. In some embodiments, the fatty acid salt can be present in the physical treatment in an amount of about 5% by mass. In some embodiments, the fatty acid salt includes a C16 fatty acid salt, a C18 fatty acid salt, or a combination thereof. In some embodiments, the fatty acid salt includes a C16 fatty acid salt and a C18 fatty acid salt. In some embodiments, the physical treatment further comprises additives, including, but not limited to, cells, biological signaling molecules, vitamins, minerals, acids, bases, salts, pigments, aromas, enzymes, catalysts, antifungals, antimicrobials, time-released drugs, and the like, or a combination thereof. In some embodiments, the physical treatment can be applied to the underripe produce unit in the form of a solution, suspension, or emulsion with a concentration of the physical treatment of about 1 g/L to about 50 g/L. In some embodiments, the physical treatment includes a single coating. In some embodiments, the physical treatment includes multiple coatings. In some embodiments, the physical treatment includes 2, 3, 4, or 5 coatings.

In some embodiments, treating can be treating with both a chemical treatment and a physical treatment.

In some embodiments, treating can be treating with a chemical treatment and not a physical treatment.

In some embodiments, treating can be treating with a physical treatment and not a chemical treatment.

In some embodiments, the temperature can be about 4° C. to about 15° C. In some embodiments, the temperature can be about 15° C. to about 28° C.

Also provided herein is a method for modulating the ripening of an underripe climacteric produce unit at a temperature, the method including (a) determining a second respiration rate of the underripe climacteric produce unit at the temperature, wherein a first respiration rate of the underripe climacteric produce unit at the temperature has been determined, and (b) if the second respiration rate can be at least about 10% greater than the first respiration rate, treating the underripe climacteric produce unit with a chemical treatment, a physical treatment, or both, or (c) if the second respiration rate can be less than 10% greater than the first respiration rate, (i) incubating the underripe produce unit at an incubation temperature until the respiration rate can be at least about 10% greater than first respiration rate, and subsequently treating the underripe climacteric produce unit with a chemical treatment, a physical treatment, or both, or (ii) treating the underripe climacteric produce unit with ethylene until the respiration rate can be at least about 10% greater than the first respiration rate, and subsequently treating the underripe climacteric produce unit with a chemical treatment and not a physical treatment, or a physical treatment and not a chemical treatment.

In some embodiments, the incubation temperature can be within about 10% of the temperature. In some embodiments, the incubation temperature can be about 4° C. to about 15° C. In some embodiments, the incubation temperature can be about 15° C. to about 28° C. In some embodiments, incubating includes incubating the underripe climacteric produce unit in a sealed or semi-sealed volume.

In some embodiments, treating the underripe climacteric produce unit with ethylene includes treating the underripe climacteric produce unit with about 1 ppm ethylene to about 300 ppm ethylene. In some embodiments, treating the underripe climacteric produce unit with ethylene includes treating the underripe climacteric produce unit with ethylene for about 8 hours to about 6 days.

In some embodiments, determination of the first respiration rate was performed at least 24 hours after the underripe climacteric produce unit was harvested. In some embodiments, determination of the first respiration rate was performed at least 48 hours after the underripe climacteric produce unit was harvested. In some embodiments, determination of the first respiration rate was performed at least 4 days after the underripe climacteric produce unit was harvested. In some embodiments, determination of the first respiration rate was performed at least 1 week after the underripe climacteric produce unit was harvested. In some embodiments, determination of the first respiration rate was performed at least 2 weeks after the underripe climacteric produce unit was harvested.

In some embodiments, determination of the first respiration rate was performed less than 3 weeks after the underripe climacteric produce unit was harvested. In some embodiments, determination of the first respiration rate was performed less than 2 weeks after the underripe climacteric produce unit was harvested. In some embodiments, determination of the first respiration rate was performed less than 1 week after the underripe climacteric produce unit was harvested. In some embodiments, determination of the first respiration rate was performed less than 4 days after the underripe climacteric produce unit was harvested. In some embodiments, determination of the first respiration rate was performed less than 48 hours after the underripe climacteric produce unit was harvested.

In some embodiments, determining the second respiration rate can be performed at least 24 hours after determination of the first respiration rate. In some embodiments, determining the second respiration rate can be performed at least 48 hours after determination of the first respiration rate. In some embodiments, determining the second respiration rate can be performed at least 4 days after determination of the first respiration rate. In some embodiments, determining the second respiration rate can be performed at least 1 week after determination of the first respiration rate. In some embodiments, determining the second respiration rate can be performed at least 2 weeks after determination of the first respiration rate.

In some embodiments, determining the second respiration rate can be performed less than 3 weeks after determination of the first respiration rate. In some embodiments, determining the second respiration rate can be performed less than 2 weeks after determination of the first respiration rate. In some embodiments, determining the second respiration rate can be performed less than 1 week after determination of the first respiration rate. In some embodiments, determining the second respiration rate can be performed less than 4 days after determination of the first respiration rate. In some embodiments, determining the second respiration rate can be performed less than 48 hours after determination of the first respiration rate.

In some embodiments, the first respiration rate can be a baseline respiration rate for the underripe climacteric produce unit at the temperature.

In some embodiments, the first respiration rate can be a transient respiration rate for the underripe climacteric produce unit at the temperature.

In some embodiments, the second respiration rate can be at least 15% greater than the first respiration rate. In some embodiments, the second respiration rate can be at least 20% greater than the first respiration rate. In some embodiments, the second respiration rate can be at least 30% greater than the first respiration rate. In some embodiments, the second respiration rate can be about 10% to about 15% greater than the first respiration rate. In some embodiments, the second respiration rate can be about 10% to about 20% greater than the first respiration rate. In some embodiments, the second respiration rate can be about 10% to about 30% greater than the first respiration rate.

In some embodiments, the method further includes, prior to determining the second respiration rate, determining the first respiration rate.

In some embodiments, modulating the ripening of the underripe climacteric produce unit includes extending a duration of time in which the underripe climacteric produce unit can be underripe. In some embodiments, modulating the ripening of the underripe climacteric produce unit includes increasing the total number of days that the underripe climacteric produce unit can be in stage 1 or stage 2. In some embodiments, modulating the ripening of the underripe climacteric produce unit includes extending a duration of time that the underripe climacteric produce unit can be acceptably ripe. In some embodiments, modulating the ripening of the underripe climacteric produce unit includes increasing the total number of days that the climacteric produce unit can be in stage 3, stage 4, or stage 5. In some embodiments, modulating the ripening of the underripe climacteric produce unit includes extending a shelf life of the climacteric produce unit. In some embodiments, modulating the ripening of the underripe climacteric produce unit includes increasing the total number of days that the climacteric produce unit can be in stage 1, stage 2, stage 3, stage 4, or stage 5. In some embodiments, modulating the ripening of the underripe climacteric produce unit includes delaying a senescent response, decreasing the intensity of senescent response, or both. In some embodiments, the senescent response can be selected from the group consisting of a color change, softening, starch metabolism, mass loss, wrinkling, a fibrous appearance, and a combination thereof. In some embodiments, a color change includes browning, yellowing, blackening, or a combination thereof. In some embodiments, modulating the ripening of the underripe climacteric produce unit includes decreasing susceptibility of the underripe climacteric produce unit to a biological stressor associated with produce spoilage. In some embodiments, the biological stressor associated with produce spoilage can be selected from the group consisting of fungi, bacteria, and a combination thereof. In some embodiments, the fungi can be selected from the group consisting of mold, yeast, and a combination thereof.

In some embodiments, the climacteric produce unit can be selected from the group consisting of an apple, an apricot, an avocado, a banana, a blueberry, a bayberry, a custard apple, a fig, a guava, a kiwifruit, a lychee, a mamey sapote, a mango, a melon, a mountain papaya, a nectarine, a papaya, a peach, a pear, a persimmon, a plum, a tomato, and a combination thereof.

In some embodiments, the underripe climacteric produce unit can be an avocado. In some embodiments, modulating the ripening of the avocado includes increasing the total number of days that the avocado can be in stage 1 or stage 2. In some embodiments, modulating the ripening of the avocado includes increasing the total number of days that the avocado can be in stage 3, stage 4, or stage 5.

In some embodiments, the chemical treatment includes an inhibitor of an ethylene receptor. In some embodiments, the inhibitor of the ethylene receptor can be selected from the group consisting of diazocyclopentadiene (DACP), cyclopropene (CP), 1-methylcyclopropene (1-MCP), 3,3-dimethylcyclopropene (3,3-DMCP), and a combination thereof. In some embodiments, the inhibitor of the ethylene receptor can be 1-MCP. In some embodiments, the temperature can be above the boiling point of the inhibitor of the ethylene receptor. In some embodiments, the temperature can be below the boiling point of the inhibitor of the ethylene receptor. In some embodiments, the underripe climacteric produce unit can be contained in a volume (in liters), and treating with the chemical treatment includes applying the chemical treatment in an amount of about 0.01 mg/liter volume to about 0.1 mg/liter volume. In some embodiments, the chemical treatment includes applying the chemical treatment in an amount of about 0.01 mg/liter volume to about 0.03 mg/liter volume. In some embodiments, treating with the chemical treatment includes applying the chemical treatment in an amount of about 0.02 mg/liter volume to about 0.07 mg/liter volume. In some embodiments, treating with the chemical treatment includes exposing the underripe climacteric produce unit to the chemical treatment for a period of about 1 hour to about 24 hours. In some embodiments, treating with the chemical treatment includes exposing the underripe climacteric produce unit to the chemical treatment for a period of about 6 hours to about 18 hours. In some embodiments, treating with the chemical treatment includes exposing the underripe climacteric produce unit to the chemical treatment for a period of about 6 hours to about 12 hours.

In some embodiments, the physical treatment includes a coating. In some embodiments, the physical treatment includes a monoglyceride and a fatty acid salt. In some embodiments, the monoglyceride can be present in the physical treatment in an amount of about 50% to about 99% by mass. In some embodiments, the monoglyceride can be present in the physical treatment in an amount of about 90% to about 99% by mass. In some embodiments, the monoglyceride can be present in the physical treatment in an amount of about 95% by mass. In some embodiments, the monoglyceride includes monoglycerides having carbon chain lengths longer than or equal to 10 carbons (e.g., longer than 11, longer than 12, longer than 14, longer than 16, longer than 18). In some embodiments, the monoglyceride includes monoglycerides having carbon chain lengths shorter than or equal to 20 carbons (e.g., shorter than 18, shorter than 16, shorter than 14, shorter than 12, shorter than 11, shorter than 10). In some embodiments, the monoglyceride includes a C16 monoglyceride and a C18 monoglyceride. In some embodiments, the fatty acid salt can be present in the physical treatment in an amount of about 1% to about 50% by mass. In some embodiments, the fatty acid salt can be present in the physical treatment in an amount of about 1% to about 10% by mass. In some embodiments, the fatty acid salt can be present in the physical treatment in an amount of about 5% by mass. In some embodiments, the fatty acid salt includes a C16 fatty acid salt, a C18 fatty acid salt, or a combination thereof. In some embodiments, the fatty acid salt includes a C16 fatty acid salt and a C18 fatty acid salt. In some embodiments, the C16 fatty acid salt and the C18 fatty acid salt are present in an approximate 50:50 ratio. In some embodiments, the physical treatment further comprises additives, including, but not limited to, cells, biological signaling molecules, vitamins, minerals, acids, bases, salts, pigments, aromas, enzymes, catalysts, antifungals, antimicrobials, time-released drugs, and the like, or a combination thereof. In some embodiments, the physical treatment can be applied to the underripe climacteric produce unit in the form of a solution, suspension, or emulsion with a concentration of the physical treatment of about 1 g/L to about 50 g/L. In some embodiments, physical treatment includes a single coating. In some embodiments, the physical treatment includes multiple coatings. In some embodiments, the physical treatment includes 2, 3, 4, or 5 coatings.

In some embodiments, the treating can be treating with both a chemical treatment and a physical treatment.

In some embodiments, the treating can be treating with a chemical treatment and not a physical treatment.

In some embodiments, the treating can be treating with a physical treatment and not a chemical treatment.

In some embodiments, the temperature can be about 4° C. to about 15° C. In some embodiments, the temperature can be about 15° C. to about 28° C.

Also provided herein is a method of treating an underripe produce unit, the method including adding to an enclosed or semi-enclosed volume including an underripe produce unit a chemical treatment, wherein the enclosed or semi-enclosed volume can be at a temperature between about 4° C. and about 14° C.

Also provided herein is a method for modulating the ripening of an underripe produce unit, the method including a) adding to an enclosed or semi-enclosed volume including an underripe produce unit a chemical treatment, wherein the enclosed or semi-enclosed volume can be at a temperature between about 4° C. and about 14° C., (b) determining that the underripe produce unit should be ripened, shipped, or both, and (c) increasing the temperature of the enclosed or semi-enclosed volume to at least about 14° C.

In some embodiments, the underripe produce unit can be a climacteric produce unit. In some embodiments, the climacteric produce unit can be selected from the group consisting of an apple, an apricot, an avocado, a banana, a blueberry, a bayberry, a custard apple, a fig, a guava, a kiwifruit, a lychee, a mamey sapote, a mango, a melon, a mountain papaya, a nectarine, a papaya, a peach, a pear, a persimmon, a plum, a tomato, and a combination thereof.

In some embodiments, the underripe produce unit can be a non-climacteric produce unit. In some embodiments, the non-climacteric produce unit can be selected from the group consisting of a cherry, a clementine mandarin, a cucumber, a grape, a grapefruit, a lime, an orange, a pepper, a pineapple, a strawberry, a watermelon, and a combination thereof.

In some embodiments, the underripe produce unit can be an avocado. In some embodiments, the chemical treatment includes an inhibitor of an ethylene receptor. In some embodiments, the inhibitor of the ethylene receptor can be selected from the group consisting of diazocyclopentadiene (DACP), cyclopropene (CP), 1-methylcyclopropene (1-MCP), 3,3-dimethylcyclopropene (3,3-DMCP), and a combination thereof. In some embodiments, the inhibitor of the ethylene receptor can be 1-MCP. In some embodiments, the chemical treatment can be added to the enclosed or semi-enclosed volume in an amount of about 0.01 mg/liter volume to about 0.1 mg/liter volume. In some embodiments, the chemical treatment can be added to the enclosed or semi-enclosed volume in an amount of about 0.01 mg/liter volume to about 0.03 mg/liter volume. In some embodiments, the chemical treatment can be added to the enclosed or semi-enclosed volume in an amount of about 0.02 mg/liter volume to about 0.07 mg/liter volume.

Also provided herein is a treated produce unit including a produce unit, and a chemical treatment, a physical treatment, or both, wherein the produce unit can be in stage 3, stage 4, or stage 5 for at least 5 days.

In some embodiments, the produce unit can be in stage 3, stage 4, or stage 5 for at least 7 days. In some embodiments, the produce unit can be in stage 3, stage 4, or stage 5 for at least 10 days. In some embodiments, the produce unit can be in stage 3, stage 4, or stage 5 for at least 14 days. In some embodiments, the produce unit can be in stage 3, stage 4, or stage 5 for at least 18 days. In some embodiments, the produce unit can be in stage 3, stage 4, or stage 5 for at least 21 days. In some embodiments, the produce unit can be in stage 3, stage 4, or stage 5 for at least 30 days. In some embodiments, the produce unit can be in stage 3, stage 4, or stage 5 for at least 2 months. In some embodiments, the produce unit can be in stage 3, stage 4, or stage 5 for at least 3 months. In some embodiments, the produce unit can be in stage 3, stage 4, or stage 5 for at least 4 months. In some embodiments, the produce unit can be in stage 3, stage 4, or stage 5 for at least 5 months. In some embodiments, the produce unit can be in stage 3, stage 4, or stage 5 for at least 6 months.

In some embodiments, the treated produce unit includes both a chemical treatment and a physical treatment.

In some embodiments, the treated produce unit includes a chemical treatment and not a physical treatment.

In some embodiments, the treated produce unit includes a physical treatment and not a chemical treatment.

Also provided herein is a treated produce unit including a produce unit, a chemical treatment, and a physical treatment.

In some embodiments, when not treated with exogenous ethylene, a mass loss rate of the treated produce unit can be lower than a mass loss rate of a similarly treated produce unit including a chemical treatment but not a physical treatment, and wherein the respiration rate of the treated produce unit can be higher than a similarly treated produce unit including a physical treatment but not a chemical treatment.

In some embodiments, the treated produce unit can be a climacteric produce unit. In some embodiments, the climacteric produce unit can be selected from the group consisting of an apple, an apricot, an avocado, a banana, a blueberry, a bayberry, a custard apple, a fig, a guava, a kiwifruit, a lychee, a mamey sapote, a mango, a melon, a mountain papaya, a nectarine, a papaya, a peach, a pear, a persimmon, a plum, a tomato, and a combination thereof.

In some embodiments, the treated produce unit can be a non-climacteric produce unit. In some embodiments, the non-climacteric produce unit can be selected from the group consisting of a cherry, a clementine mandarin, a cucumber, a grape, a grapefruit, a lime, an orange, a pepper, a pineapple, a strawberry, a watermelon, and a combination thereof.

In some embodiments, the treated produce unit can be an avocado.

In some embodiments, the chemical treatment includes an inhibitor of an ethylene receptor. In some embodiments, the inhibitor of the ethylene receptor can be selected from the group consisting of diazocyclopentadiene (DACP), cyclopropene (CP), 1-methylcyclopropene (1-MCP), 3,3-dimethylcyclopropene (3,3-DMCP), and a combination thereof. In some embodiments, the inhibitor of the ethylene receptor can be 1-MCP.

In some embodiments, the physical treatment includes a coating. In some embodiments, the physical treatment includes a monoglyceride and a fatty acid salt. In some embodiments, the monoglyceride can be present in the physical treatment in an amount of about 50% to about 99% by mass. In some embodiments, the monoglyceride can be present in the physical treatment in an amount of about 90% to about 99% by mass. In some embodiments, the monoglyceride can be present in the physical treatment in an amount of about 95% by mass. In some embodiments, the monoglyceride includes monoglycerides having carbon chain lengths longer than or equal to 10 carbons (e.g., longer than 11, longer than 12, longer than 14, longer than 16, longer than 18). In some embodiments, the monoglyceride includes monoglycerides having carbon chain lengths shorter than or equal to 20 carbons (e.g., shorter than 18, shorter than 16, shorter than 14, shorter than 12, shorter than 11, shorter than 10). In some embodiments, the monoglyceride includes a C16 monoglyceride and a C18 monoglyceride. In some embodiments, the fatty acid salt can be present in the physical treatment in an amount of about 1% to about 50% by mass. In some embodiments, the fatty acid salt can be present in the physical treatment in an amount of about 1% to about 10% by mass. In some embodiments, the fatty acid salt can be present in the physical treatment in an amount of about 5% by mass. In some embodiments, the fatty acid salt includes a C16 fatty acid salt, a C18 fatty acid salt, or a combination thereof. In some embodiments, the fatty acid salt includes a C16 fatty acid salt and a C18 fatty acid salt. In some embodiments, the physical treatment comprises additives, including, but not limited to, cells, biological signaling molecules, vitamins, minerals, acids, bases, salts, pigments, aromas, enzymes, catalysts, antifungals, antimicrobials, time-released drugs, and the like, or a combination thereof. In some embodiments, the physical treatment includes a single coating. In some embodiments, the physical treatment includes multiple coatings. In some embodiments, the physical treatment includes 2, 3, 4, or 5 coatings.

All publications, patents, patent applications, and information available on the internet and mentioned in this specification are herein incorporated by reference to the same extent as if each individual publication, patent, patent application, or item of information was specifically and individually indicated to be incorporated by reference. To the extent publications, patents, patent applications, and items of information incorporated by reference contradict the disclosure contained in the specification, the specification is intended to supersede and/or take precedence over any such contradictory material.

Where values are described in terms of ranges, it should be understood that the description includes the disclosure of all possible sub-ranges within such ranges, as well as specific numerical values that fall within such ranges irrespective of whether a specific numerical value or specific sub-range is expressly stated.

The term “each,” when used in reference to a collection of items, is intended to identify an individual item in the collection but does not necessarily refer to every item in the collection, unless expressly stated otherwise, or unless the context of the usage clearly indicates otherwise.

Various embodiments of the features of this disclosure are described herein. However, it should be understood that such embodiments are provided merely by way of example, and numerous variations, changes, and substitutions can occur to those skilled in the art without departing from the scope of this disclosure. It should also be understood that various alternatives to the specific embodiments described herein are also within the scope of this disclosure.

### DESCRIPTION OF THE DRAWINGS

The following drawings illustrate certain embodiments of the features and advantages of this disclosure. These embodiments are not intended to limit the scope of the appended claims in any manner.

FIG. 1 is a qualitative plot of the ripeness of a produce unit with no treatment (solid line), early treatment (dotted line), and later treatment (dashed line).

FIG. 2A is a qualitative plot of the ripeness of a produce unit with no treatment (solid line), and application of ethylene and a treatment (dashed line).

FIG. 2B is a qualitative plot of the ripeness of a produce unit with no treatment (solid line), and with application of a treatment (dashed line).

FIG. 3A is a qualitative plot indicating various stages of ripeness, which can generally be applied to produce.

FIG. 3B represents these stages (right axis) with avocados as an exemplary ripeness as indicated by firmness (left axis), either when treated with a chemical and/or physical treatment (green data) or not treated (gray data).

FIG. 4A is a plot of the respiration rate of untreated avocados (circles) and avocados treated with 2 (squares), 4 (diamonds), or 6 (triangles) packets of 1-MCP.

FIG. 4B is a plot of the durometer stage of untreated avocados (circles) and avocados treated with 6 packets of 1-MCP (triangles).

FIG. 5A is an image of avocados treated with 1-MCP displaying exterior checkerboarding.

FIG. 5B is an image of avocados treated with 1-MCP displaying mold and flesh adhesion in some units.

FIG. 6A is a plot of the respiration rate of untreated avocados (circles) and avocados treated with 1-MCP at stage 1 (squares) or stage 3/4 (diamonds).

FIG. 6B is an image of avocados at approximately 40 shore displaying mold and vascular browning in various treatment groups.

FIG. 7A is a plot of the respiration rate of untreated avocados (circles) and avocados treated with 1-MCP after removal from 4.5° C. storage (squares), after the avocados spent 2 hours at ambient (diamonds), and after the avocados spent 6 hours at ambient (triangles).

FIG. 7B is a plot of the durometer stage of untreated avocados (circles) and avocados treated with 1-MCP after removal from 4.5° C. storage (squares), after the avocados spent 2 hours at ambient (diamonds), and after the avocados spent 6 hours at ambient (triangles).

FIG. 8A is a plot of the respiration rate of untreated avocados (circles), and avocados treated with 1 layer (squares) or 3 layers (diamonds) of a combination of physical treatment B (40 g/L) and 2 g/L glycerol monocaprate.

FIG. 8B is an image of avocados displaying sunken patches, vascular browning, and mold.

FIG. 9A is a plot of relative ripening state based on peak CO₂ production over three weeks (week 1—circles; week 2—squares, week 3—diamonds).

FIG. 9B is a plot of confidence of ripening without issue based on peak respiration rate.

FIG. 10A is a plot of the mass loss factor (MLF) of untreated avocados (black) and avocados treated with physical treatment A at 12 g/L (checkered), 22 g/L (white), and 32 g/L (stripes), either before (center bars) or after (right bars) ethylene treatment.

FIG. 10B is a plot of the respiration rate of untreated avocados (circles) and avocados treated with physical treatment A at 12 g/L (squares), 22 g/L (diamonds), and 32 g/L (triangles) either before (black) or after (white) ethylene treatment.

FIG. 10C is a plot of the firmness of untreated avocados (circles) and avocados treated with physical treatment A at 12 g/L (squares), 22 g/L (diamonds), and 32 g/L (triangles) either before (black) or after (white) ethylene treatment.

FIG. 10D is a plot of the assessment of untreated avocados and avocados treated with physical treatment A at 12 g/L, 22 g/L, and 32 g/L either before or after ethylene treatment.

FIG. 11 is a plot of the respiration rate of untreated avocados (circles) and avocados treated with 1-MCP with (diamonds) or without (squares) subsequent ethylene treatment.

FIG. 12A is a plot of the mass loss rate of cucumbers exposed (black) or not exposed (white) to exogenous ethylene (2 ppm) after 5 days with various treatment conditions.

FIG. 12B is a plot of the respiration rate of cucumbers exposed (black) or not exposed (white) to exogenous ethylene (2 ppm) after 5 days with various treatment conditions.

FIG. 12C is an image of cucumbers before and after 5 days of exposure to exogenous ethylene (2 ppm) with various treatment conditions.

FIG. 12D is an image of cucumbers after 10 days of no exposure to exogenous ethylene for 10 days with various treatment conditions.

FIG. 13A is a plot of the mass loss rate of Persian limes exposed (black) or not exposed (white) to exogenous ethylene (2 ppm) after 5 days with various treatment conditions.

FIG. 13B is a plot of the respiration rate of Persian limes exposed (black) or not exposed (white) to exogenous ethylene (2 ppm) after 5 days with various treatment conditions.

FIG. 13C is an image of Persian limes before and after 5 days of exposure ambient conditions with various treatment conditions.

FIG. 13D is an image of Persian limes before and after 14 days of exposure ambient conditions with various treatment conditions.

FIG. 13E is an image of Persian limes before and after 5 days of exposure to exogenous ethylene (2 ppm) with various treatment conditions.

### DETAILED DESCRIPTION

### Definitions

As used herein, “climacteric respiration” is understood to mean an increased level of cellular respiration associated with increased ethylene production and stage of ripening for certain species of produce.

As used herein, the “respiration rate” of a product such as produce (e.g., a produce unit) refers to the rate at which the product releases CO₂, and more specifically is the volume of CO₂ (at standard temperature and pressure) released per unit time per unit mass of the product. In some embodiments, the respiration rate of a product can be measured by placing the product in a closed container of known volume that is equipped with a CO₂ sensor, recording the CO₂ concentration within the container as a function of time, and then calculating the rate of CO₂ release required to obtain the measured concentration values. In some cases, the respiration rate of multiple produce units in a volume (e.g., a sealed or semi-sealed volume) is measured in a single measurement (e.g., as an average). It is understood that respiration rate may be determined by indirect methods, including, but not limited to, hyperspectral imaging, NIR, and other imaging or characterization processes.

As used herein, a “baseline respiration rate” of a product such as produce (e.g., a produce unit) refers to a respiration rate measured within 72 hours after harvest (e.g., within 48 hours of harvest, within 36 hours of harvest, or within 24 hours of harvest.

As used herein, a “transient respiration rate” of a product such as produce (e.g., a produce unit) refers to a respiration rate measured at any time in the ripening process, such as after a baseline respiration rate.

As used herein, the term “respiration factor” is defined as the ratio of the cumulative respiration of uncoated produce (measured for a control group) to the cumulative respiration of the corresponding coated produce. Hence, a larger respiration factor corresponds to a greater reduction in cumulative respiration for the coated produce.

As used herein, the term “mass loss factor” (sometimes also called MLF) is defined as the ratio of the average mass loss rate of uncoated produce (measured for a control group) to the average mass loss rate of the corresponding coated produce at a given time. Hence a larger mass loss factor corresponds to a greater reduction in average mass loss rate for the coated produce.

As used herein, the “mass loss rate” refers to the rate at which the product loses mass (e.g. by releasing water and other volatile compounds). The mass loss rate is typically expressed as a percentage of the original mass per unit time (e.g., percent per day).

As used herein, the term “climacteric produce” or “climacteric fruit” refers to produce or fruit which continue to ripen after being harvested or removed from the plant. Ripening in climacteric produce is associated with increased ethylene production and a rise in cellular respiration. Examples include, but are not limited to, apples, bananas, mangos, papayas, pears, apricots, peaches, plums, avocados, plantains, guavas, nectarines, passion fruit, blueberries, and cantaloupes.

As used herein, the term “ethylene sensitive produce” or “ethylene sensitive fruit” refers to produce or fruit which are sensitive to ethylene gas and which exposure thereto may cause premature ripening and/or spoilage of the ethylene sensitive produce. Examples include, but are not limited to, asparagus, broccoli, cabbage, cucumber, unripe bananas, berries such as raspberries and strawberries, and melons, such as cantaloupe and watermelon.

As used herein, the term “physical treatment” refers to any compound or combination of compounds that can create a physical barrier on a surface that limits or reduces the rate of diffusion of gaseous molecules (e.g., ethylene, CO₂, O₂, among others) into a produce unit. Non-limiting exemplary physical treatments are described in U.S. Pat. Nos. 10,092,014, 10,407,377 and 10,537,115 and U.S. Patent Application Publication Nos. 20180368427(A1) and 20190269145(A1), each of which is incorporated herein by reference in its entirety.

As used herein, the term “chemical treatment” refers to any compound or combination of compounds that block one or more receptors of gaseous molecules (e.g., ethylene, CO₂, O₂, among others) that modulate ripening within a produce unit. In some embodiments, a chemical treatment is a compound or combination of compounds that blocks ethylene receptors.

As used herein, the term “plant matter” refers to any portion of a plant, including, for example, fruits (in the botanical sense, including fruit peels and juice sacs), vegetables, leaves, stems, barks, seeds, flowers, peels, roots, or oils. Plant matter includes pre-harvest plants or portions thereof as well as post-harvest plants or portions thereof, including, e.g., harvested fruits and vegetables, harvested roots and berries, and picked flowers.

Many types of produce and other agricultural products (e.g., fruits, vegetables, roots, tubers, flowers) are harvested prior to complete ripening and then allowed to fully ripen post-harvest, for example during storage or shipping. As used herein, an agricultural product to which the methods described herein apply can be called a “produce unit”. While the practice of early harvesting generally necessitates storing the produce for longer periods of time after harvesting and before consumption, it also increases the amount of time between harvesting and spoilage of the produce, thereby allowing the produce to be shipped to more remote locations and be more widely distributed than would otherwise be possible if it were harvested closer to complete ripening. Furthermore, some types of produce (e.g., climacteric fruit such as bananas and avocados) never fully ripen prior to harvesting, and therefore are stored post-harvest for at least some amount of time prior to consumption. In many cases, produce which has been harvested prior to complete ripening is subsequently treated with a ripening agent, for example ethylene gas, in order to increase the rate of ripening. However, for seasonal products, it is still the case that there can be an oversupply of the products during the peak of the season, while after the season ends the products become unavailable or in some cases must be imported from remote locations.

In the case of climacteric produce (e.g., apples, pears, bananas, mangos, avocados, and various stone fruit, among others), exposure to ethylene gas, either produced by the produce (e.g., endogenous ethylene) or from an external source (e.g., exogenous ethylene), triggers an increase in the respiration of the produce and causes the produce to ripen and senesce. In certain produce categories (e.g., ethylene sensitive produce categories such as cucumbers, broccoli), ethylene does not induce a concomitant increase in respiration, but can induce senescent responses (e.g., color change, browning, softening, starch metabolism, softening, among others) and/or increase susceptibility toward biological stressors (e.g., mold, bacteria, yeast, among others) associated with produce spoilage. Therefore, in climacteric and ethylene sensitive produce categories, limiting or controlling the exposure of ethylene (e.g., from exogenous or endogenous ethylene) to the produce (e.g., to ethylene receptors within the produce) can serve to delay ripening (e.g. time to ripeness and/or one or more senescent responses) and/or senescence of the produce, thereby extending the produce shelf life.

Limiting the exposure of produce to ethylene can be accomplished through, for example, physical or chemical treatment. For example, a physical treatment (e.g., a coating) can be used to block or limit diffusion of ethylene, among other gases (e.g., O₂, CO₂), into the produce, thereby reducing the rate of ethylene perception and slowing ripening and/or senescence. However, if the properties of the physical treatment and the timing of application are not carefully controlled, it is possible that the produce may not fully ripen, or the physical treatment may induce deleterious side effects that render the produce inedible (e.g., decay from biotic stressors such as fungi (e.g., mold and/or yeast) and/or bacteria, off flavors due to anaerobic respiration, and/or deleterious modulation of endogenous enzymatic pathways, or physical defects, among others). Alternatively, for example, ripening and senescence can be slowed by exposure of the produce to chemical treatment (e.g., an ethylene inhibitor) such as 1-methylcycloprene (herein “1-MCP”), which, without wishing to be bound to theory, acts to block the effects of the ethylene, thereby reducing ethylene perception. However, as described in more detail below, it has been found that if the produce is exposed to a chemical treatment prior to being at a sufficiently mature state of ripening, the produce may never fully ripen post-harvest, or may experience unintended quality issues (e.g., decay from biotic stressors such as fungi (e.g., mold and/or yeast) and/or bacteria, off flavors due to anaerobic respiration and/or deleterious modulation of endogenous enzymatic pathways, or physical defects, among others). Thus, for methods to extend the shelf life of a produce unit that involve physical or chemical treatment, the conditions under which the treatment is employed should be carefully regulated to ensure that the produce units fully ripen without deleterious side effects (e.g., decay from biotic stressors such as fungi (e.g., mold and/or yeast) and/or bacteria, off flavors due to anaerobic respiration and/or deleterious modulation of endogenous enzymatic pathways, or physical defects, among others) and stay in a state of being ripe for as long as possible.

In many types of produce units (e.g., climacteric produce), the onset of increased ethylene production and corresponding onset of ripening has been found to be accompanied by an increase in the rate of climacteric respiration of the produce unit. This process can, in some instances, be modulated by tuning ethylene perception either through chemical or physical treatment. Furthermore, reducing the rate of endogenous ethylene production and/or exogenous ethylene exposure can also cause a reduction in the respiration rate of the produce unit and/or a shift in the respiratory peak thereby delaying produce spoilage (e.g., senescence). Accordingly, in some embodiments, a respiration rate of the produce unit can be used as an indicator for when to apply an ethylene inhibitor in order to allow for increased effect. In other embodiments, ripeness may be determined by indirect methods, including, but not limited to, hyperspectral imaging, NIR, and other imaging or characterization processes.

In some types of agriculture products (e.g., ethylene-sensitive produce), ethylene perception can initiate or accelerate senescent pathways without a concomitant increase in respiration rate. In this context, reducing the rate of ethylene perception by physical or chemical treatment can reduce the rate of produce spoilage (e.g., senescence), thereby extending the edible shelf life of the produce.

Described herein, in some embodiments, are methods for modulating (e.g., delaying, controlling) the rate of ripening (e.g., ripening and/or senescence) of produce units such as harvested produce. In some embodiments, the methods can include chemical treatment, such as the use of an ethylene inhibitor (e.g., 1-MCP). In some embodiments, a chemical treatment can include causing the produce unit to reach a stage of ripening corresponding to a respiration rate that is substantially greater than the respiration rate immediately after the produce unit are harvested (e.g., by using exogenous ethylene), and then applying a chemical treatment (e.g., an ethylene inhibitor such as, for example, 1-MCP), thereby causing a substantial decrease in the respiration rate. In some embodiments, a chemical treatment can include harvesting the produce unit in a ripened state, then applying a chemical treatment (e.g., an ethylene inhibitor such as, for example, 1-MCP) to decrease the rate of ethylene perception, thereby causing a substantial decrease in the rate of spoilage (e.g., senescence). In some embodiments, the methods can include physical treatment, such as the use of a coating. In some embodiments, a physical treatment can include causing the produce unit to reach a stage of ripening corresponding to a respiration rate that is substantially greater than the respiration rate immediately after the produce unit is harvested (e.g., by using exogenous ethylene), and then applying a physical treatment (e.g., a coating), thereby causing a substantial decrease in the respiration rate. In some embodiments, a physical treatment can include harvesting the produce unit in a ripened state, then applying a physical treatment (e.g., a coating) to decrease the rate of ethylene diffusion, thereby causing a substantial decrease in the rate of spoilage (e.g., senescence). In some embodiments, chemical treatment (e.g., use of ethylene inhibitors such as, for example, 1-MCP) of controlling the rate of ripening can used in combination (e.g., simultaneously, sequentially) with physical treatment (e.g., coatings) of controlling the rate of ripening (e.g., ripening and/or senescence).

Produce is generally deemed to be ripe when it is in a state of maturity such that a consumer would consider it fit for consumption (e.g., stages 3-5, as described herein). While some produce can be harvested in a ripe state, other produce categories can be or are necessarily harvested before they are ripe. In all cases, once ripened the produce will remain in a ripened state (e.g., a state where it is fit to be consumed) for a period of time until senescence renders the produce no longer fit for consumption. A number of factors, such as color, texture, and firmness (or softness), figure into a consumer's determination of when a produce unit is ripe as well as when the produce unit is spoiled. These various ripeness determination factors are weighted differently by consumers for different produce unit. For example, in the case of tomatoes, color (e.g., how red the tomato appears and the corresponding color index of the tomato) is typically the most important factor in a consumer's determination of ripeness, while firmness and/or skin texture is typically used by a consumer to determine when a tomato has spoiled.

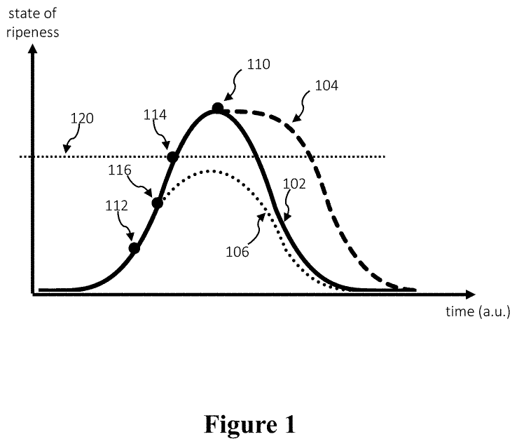

FIG. 1 is a qualitative plot indicating the relative state of ripening of produce as a function of time for produce that is harvested prior to being ripe, where curve 102 represents the typical ripening cycle of produce harvested at a time corresponding to point 112. Dotted line 120 represents the relative level of ripening (e.g., the relative state of one or more factors used by a consumer to determine whether the produce is ripe) at which a consumer would consider the produce to be ripe. After being harvested and prior to reaching the state of being ripe, the produce ages and matures until the time corresponding to point 114, after which it is considered to have ripened. As the produce continues to age, its state of ripening eventually falls below line 120 again, at which point it is considered to be spoiled.

The time between when the produce is ripe (e.g., point 114 on curve 102 in FIG. 1) and when the produce spoils can be extended by physical treatment (e.g., applying a coating), by chemical treatment (e.g., applying an ethylene inhibitor, such as, for example, 1-MCP), or a combination thereof. To realize and/or optimize this increase in the shelf life of the produce, it may be necessary to utilize a treatment (e.g., physical treatment, chemical treatment, or a combination thereof) while the produce is at a suitable stage of ripening. For example, curve 104 indicates the ripeness level of produce exposed to a treatment at the time corresponding to point 110, after the produce has allowed to reach a stage at which it's considered ripe and before it has spoiled.

Although point 110 is shown to be near the top of ripening curve 102, the treatment could be applied at any time corresponding to curve 102 being above line 120 or slightly below line 120 (e.g., slightly before time 114). As shown, the treatment can allow the produce to remain ripe for a longer period of time than would have occurred without application of the treatment (e.g., curve 102). However, in many cases (e.g., with avocados), if the treatment is applied too early in the ripening cycle, or reduces the rate or ethylene perception too much, the produce may never reach a complete stage of ripening, or may experience unintended quality issues that render the produce inedible (e.g., decay from biotic stressors such as mold (e.g., fungi), yeast, and/or bacteria, off flavors due to anaerobic respiration and/or deleterious modulation of endogenous enzymatic pathways, or physical defects, among others). For example, curve 106 represents produce that has been harvested at the time corresponding to point 112 and treated (e.g., by chemical treatment, physical treatment, or a combination thereof) at the time corresponding to point 116, at which time the produce has only achieved a slightly greater level or ripeness than when it was harvested and is before the produce is fully ripe or close to fully ripe. In this case, the state of ripening of the produce begins to decrease prior to the produce attaining a state of ripeness at which a consumer would consider the produce to be ripe, and so the produce never fully ripens.

While the exact state of ripeness of most produce can be difficult to accurately assess by visual characteristics (e.g., color) or by firmness, the respiration rate of many types of produce provides a good indicator of the state of ripeness. Specifically, for many types of produce (e.g., climacteric produce), after the produce is harvested (e.g., at point 112 in FIG. 1), the respiration rate increases as the produce continues to ripen, thereby accelerating the ripening rate of the produce. If a treatment is applied to the produce before the respiration rate has substantially increased (e.g., applied at a respiration rate corresponding to point 116 in FIG. 1), or if the treatment reduces the respiration too much, then the produce may never completely ripen, or may experience unintended quality issues (e.g., decay from biotic stressors such as mold (e.g., fungi), yeast, and/or bacteria, off flavors due to anaerobic respiration and/or deleterious modulation of endogenous enzymatic pathways, or physical defects, among others). However, if the respiration rate is allowed to increase by a greater amount (e.g., at least 10%, at least 15%, at least 20%, or more) prior to applying the treatment (e.g., to a respiration rate corresponding to point 110 in FIG. 1), then the subsequent reduced ripening rate and corresponding decrease in respiration rate of the produce can increase the time that the produce remains ripe before spoilage occurs. In addition, ripeness may be determined using hyperspectral imaging, NIR, and other image processing techniques.

In view of the above, a method for treating a produce unit can, for example, increase the time the produce unit stays ripe and/or extend the shelf life of the produce unit and/or delay spoilage of the produce unit. The produce unit is harvested, and its respiration rate can be determined two or more times post-harvest. A respiration rate can be determined any number of times (e.g., two, three, four five, and so forth), until, for example, a target increase in respiration or a targeted respiration rate, is achieved. In some embodiments, a respiration rate for the produce unit is determined at regular intervals (e.g., every 6 hours, every 12 hours, every day, every 2 days, every 3 days, every 5 days, or every week). In some embodiments a respiration rate for the produce unit is determined at irregular intervals, for example, soon after harvest and/or just before shipment. It will be understood that a determination of a respiration rate that meets a target increase or target value after one or more determinations that do not meet a target increase or target value can be called a “second” determination (and similarly, the corresponding respiration rate would be a “second” respiration rate), regardless of whether or not it is the numerically second determination. Similarly, any determination previous to a determination that meets a target increase or target value can be a “first” determination (and similarly, the corresponding respiration rate would be a “first” respiration rate). In some embodiments, a first determination is the numerically first determination. In some embodiments, a first determination is of a baseline respiration rate, as described herein. In some embodiments, a first determination is not the numeric first determination. In some embodiments, a first determination is of a transient respiration rate, as described herein.

For any of the methods described herein, a first respiration rate of the produce unit (e.g., each piece of produce) (or, e.g., average respiration rate of all the produce units) soon after harvest (e.g., about 10 minutes after harvest or less) can be at least 20 mL CO₂/kg (e.g., in a range of 20-30 mL CO₂/kg, 20-40 mL CO₂/kg, 20-50 mL CO₂/kg, or 20-60 mL CO₂/kg), and the respiration rate at the time that the ethylene inhibitor is first applied can be at least 70 mL CO₂/kg (e.g., in a range of 70-80 mL CO₂/kg, 70-90 mL CO₂/kg, 70-110 mL CO₂/kg, or 70-130 mL CO₂/kg).

A respiration rate can be determined at any appropriate temperature. In some embodiments, the temperature can be about 4° C. to about 15° C. (e.g., chilled). In some embodiments, the temperature can be about 15° C. to about 28° C. (e.g., ambient).

Accordingly, in some embodiments, provided herein is a method for modulating the ripening of a produce unit (e.g., an underripe produce unit) at a temperature, the method including (a) determining a first respiration rate for the produce unit at the temperature, (b) determining a second respiration rate for the produce unit at the temperature, wherein the second respiration rate is greater than the first respiration rate, and (c) treating the produce unit with a chemical treatment, a physical treatment, or both.

In some embodiments, provided herein is a method for modulating the ripening of a produce unit (e.g., an underripe produce unit) at a temperature, the method including treating the produce unit determined to have a second respiration rate greater than a first respiration rate for the produce unit at the temperature with a chemical treatment, a physical treatment, or both.

A first respiration rate can be determined at any appropriate time point. In some embodiments, a first respiration rate can be determined at least 24 hours (e.g., at least 48 hours, at least 4 days, at least 1 week, or at least two weeks) after the produce unit was harvested. In some embodiments, a first respiration rate can be determined less than 3 weeks (e.g., less than 2 weeks, less than 1 week, less than 4 days, or less than 48 hours) after the produce unit was harvested. In some embodiments, a first respiration rate is a baseline respiration rate for the produce unit. In some embodiments, a first respiration rate is a transient respiration rate for the produce unit.

A second respiration rate can be determined at any appropriate time point. In some embodiments, a second respiration rate can be determined at least 24 hours (e.g., at least 48 hours, at least 4 days, at least 1 week, or at least 2 weeks) after determining the first respiration rate. In some embodiments, a second respiration rate can be determined less than 3 weeks (e.g., less than 2 weeks, less than 1 week, less than 4 days, or less than 48 hours) after determining the first respiration rate.

As a produce unit continues to mature and ripen, its respiration rate typically increases. A second respiration rate can be greater than a first respiration rate by any appropriate amount or degree. In some embodiments, a second respiration rate can be at least 10% greater than the first respiration rate (e.g., at least 10%, at least 15%, at least 20%, at least 25%, at least 30%, at least 35%, at least 40%, at least 45%, at least 50%, at least 55%, at least 60%, at least 65%, at least 70%, at least 75%, at least 80%, at least 85%, at least 90%, at least 95%, at least 100%, at least 110%, at least 120%, at least 130%, at least 140%, at least 150%, at least 160%, at least 170%, at least 180%, at least 190%, at least 200%, at least 210%, at least 220%, at least 230%, at least 240%, at least 250%, at least 260%, at least 270%, at least 280%, at least 290%, at least 300%, or more, greater than the first respiration rate). In some embodiments, a second respiration rate can be about 10% to about 300% greater than a first respiration rate (e.g., about 10% to about 15%, about 10% to about 20%, about 10% to about 30%, about 10% to about 50%, about 10% to about 75%, about 10% to about 100%, about 10% to about 150%, about 10% to about 200%, about 15% to about 300%, about 20% to about 300%, about 50% to about 300%, about 75% to about 300%, about 100% to about 300%, about 150% to about 300%, or about 250% to about 300% greater than the first respiration rate).

In some embodiments, a determination of a respiration rate indicates that the respiration rate of the produce unit has not yet increased by the desired amount or degree. In some such embodiments, the produce unit can be incubated (and e.g., additional determination(s) of respiration rate made) until the desired increase is observed. In some embodiments, exogenous ethylene can be applied to the produce unit (e.g., climacteric produce unit) to achieve the desired increase.

In some embodiments, at a certain time after harvesting, exogenous ethylene (e.g., ethylene that is not produced by the produce unit) can be applied to the produce unit. The ethylene can be applied to the produce unit prior to the produce unit ripening and/or prior to time at which the respiration rate of the harvested produce unit has increased too substantially as compared to the first respiration rate (e.g., soon after harvest). Without being bound by any particular theory, it is believed that, if ethylene is applied it should be done before the produce unit ripens too much naturally. For example, in some embodiments, ethylene can be applied to the produce unit if the second respiration rate is than 1.03 times, less than 1.05 times, less than 1.1 times, less than 1.15 times, less than 1.2 times, less than 1.3 times, less than 1.4 times, less than 1.5 times, less than 1.6 times, less than 1.8 times, less than 2 times, less than 2.3 times, less than 2.6 times, less than 3 times, less than 3.5 times, or less than 4 times the first respiration rate. In some embodiments, ethylene can be applied while the produce unit is at stage 1, or at stage 2.

Due to logistical constraints, in many cases it can be difficult to delay treatment until the respiration rate of the produce unit is sufficiently high. For example, from a logistical perspective, in many cases the ideal time to apply a treatment is after the sorting and packing of the produce unit(s) into containers which are then enclosed and/or sealed (or semi-sealed) for storage and/or shipping. Sorting and packing of the produce unit(s) typically occurs soon after harvesting, prior to the produce unit(s) being in a sufficiently ripe state for application of a treatment.

In some embodiments, in order to apply a treatment while the produce unit(s) are sufficiently ripe and still maintain logistical efficiency, the produce unit(s) can first be gassed with ethylene from an outside source (e.g., ethylene that is not self-produced by the produce unit(s)) to increase their average respiration rate and accelerate ripening. Once the produce units are sufficiently ripe and/or have a sufficiently high average respiration rate, a treatment can be applied, thereby reducing the respiration rate of the produce unit(s) and slowing the ripening process, which can increase the average shelf life and/or ripe time of the produce unit(s).

Applying a chemical treatment (e.g., an ethylene inhibitor) to a produce unit typically decreases the respiration rate of the produce unit, for example, when ethylene has been previously applied to the produce unit (e.g., resulting from the application of the ethylene). In some embodiments, the respiration rate of the produce unit at the time the treatment is first applied (e.g., at the earliest time of exposure to the treatment) (e.g., a second respiration rate) can be substantially greater (e.g., at least 10%, at least 15%, at least 20%, at least 25%, at least 30%, at least 35%, at least 40%, at least 45%, at least 50%, at least 55%, at least 60%, at least 65%, at least 70%, at least 75%, at least 80%, at least 85%, at least 90%, at least 95%, at least 100%, at least 110%, at least 120%, at least 130%, at least 140%, at least 150%, at least 160%, at least 170%, at least 180%, at least 190%, at least 200%, at least 210%, at least 220%, at least 230%, at least 240%, at least 250%, at least 260%, at least 270%, at least 280%, at least 290%, or at least 300% greater) than the respiration rate of the produce unit at the time the ethylene is first applied (e.g., when gassing of the produce units with ethylene first begins) (e.g., a first respiration rate). In some embodiments, the respiration rate of the produce unit at the time the treatment is first applied (e.g., at the earliest time of exposure to the treatment) (e.g., a second respiration rate) can be about 10% to about 300% greater than a first respiration rate (e.g., about 10% to about 15%, about 10% to about 20%, about 10% to about 30%, about 10% to about 50%, about 10% to about 75%, about 10% to about 100%, about 10% to about 150%, about 10% to about 200%, about 15% to about 300%, about 20% to about 300%, about 50% to about 300%, about 75% to about 300%, about 100% to about 300%, about 150% to about 300%, or about 250% to about 300% greater) than the respiration rate of the produce unit at the time the ethylene is first applied (e.g., when gassing of the produce units with ethylene first begins) (e.g., a first respiration rate).

Application of a chemical treatment (e.g., an ethylene inhibitor) can cause the respiration rate of the produce unit to decrease quickly. For example, the respiration rate of the produce unit at least about 30 minutes (e.g., about 30 minutes, about 1 hour, about 3 hours, about 6 hours, about 9 hours, about 12 hours, or about 24 hours) after the application of the chemical treatment can be less than 0.9 times, less than 0.8 times, less than 0.7 times, less than 0.6 times, less than 0.5 times, less than 0.4 times, less than 0.3 times, less than 0.2 times, or less than 0.1 times the respiration rate 5 minutes before the application of the chemical treatment.

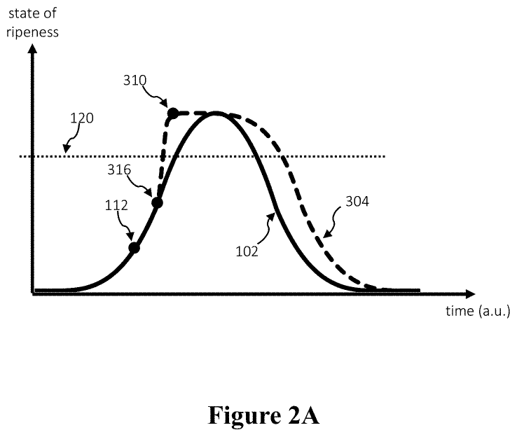

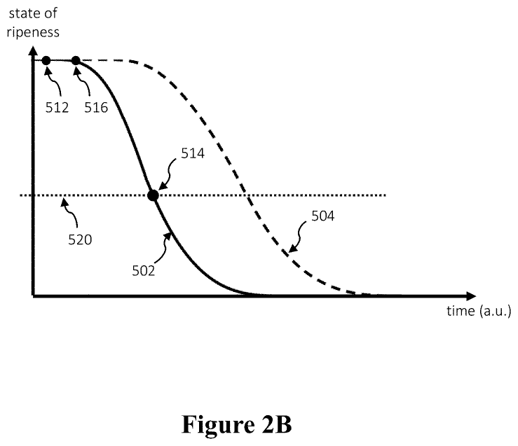

FIG. 2A is a qualitative plot indicating the relative state of ripening of produce units harvested at time 112, where ripening curve 102 (also shown in FIG. 1) corresponds to untreated produce units and ripening plot 304 corresponds to produce units that are first treated with ethylene, and then a treatment is applied (e.g., treated by chemical treatment, by physical treatment, or a combination thereof). Specifically, at the time corresponding to point 316, shortly after harvesting (at the time corresponding to point 112) and well before the produce units are ripe (where full ripeness is indicated by line 120, as in FIG. 1), ethylene from an outside source is applied to the plurality of produce units. This can cause the average ripening rate and corresponding average respiration rate of the produce units to increase rapidly, as indicated by the steeper portion of curve 304 right after the time corresponding to point 316. After the produce units are sufficiently ripe and exhibit a sufficiently high rate of respiration (e.g., at the time corresponding to point 310), a treatment is applied to the produce units. This can cause a reduction in the average respiration rate and a corresponding slowing of the physiological processes causing the produce units to continue maturing until spoilage occurs. As seen by comparing curve 304 to curve 102, this can increase the average shelf life and/or ripe time of the produce units. In some embodiments, the produce unit is treated with ethylene and subsequently treated by chemical treatment (e.g., using an ethylene inhibitor such as, for example, 1-MCP). In some embodiments, the produce unit is treated with ethylene and then subsequently treated by physical treatment (e.g., using a coating). In some embodiments, the produce unit is treated with ethylene and subsequently treated by chemical treatment (e.g., using an ethylene inhibitor such as, for example, 1-MCP) and by physical treatment (e.g., using a coating).

FIG. 2B is a qualitative plot indicating the relative senescence of produce units, starting at a peak ripeness, where ripening curve 502 corresponds to produce units that are not treated with a chemical and/or physical treatment, and ripening curve 504 corresponds to produce units that were treated with a chemical and/or physical treatment at point 512. At point 516, the curves begin to diverge, with ripening curve 502 dipping below the acceptable threshold of ripeness (line 520) at point 514. In contrast, ripening curve 504 does not dip below line 520 until a later point in time. In some embodiments, the produce unit is ripe at the time of harvest.

Accordingly, also provided herein is a method for modulating the ripening of an produce unit (e.g., an underripe produce unit (e.g., an underripe climacteric produce unit)) at a temperature, the method including (a) determining a second respiration rate of the produce unit (e.g., underripe produce unit) at the temperature, wherein a first respiration rate of the produce unit at the temperature has been determined, and (b) if the second respiration rate is at least about 10% greater than the first respiration rate, treating the produce unit with a chemical treatment, a physical treatment, or both, or (c) if the second respiration rate is less than 10% greater than the first respiration rate, (i) incubating the produce unit at an incubation temperature until the respiration rate is at least about 10% greater than first respiration rate, and subsequently treating the produce unit with a chemical treatment, a physical treatment, or both, or (ii) treating the produce unit with ethylene until the respiration rate is at least about 10% greater than the first respiration rate, and subsequently treating the produce unit with a chemical treatment and not a physical treatment, or a physical treatment and not a chemical treatment. In some embodiments, the method further includes, prior to determining the second respiration rate, determining the first respiration rate.

An incubation temperature can be any appropriate incubation temperature. In some embodiments, the incubation temperature can be within about 10% of the temperature. In some embodiments, the incubation temperature can be about 4° C. to about 15° C. (e.g., chilled). In some embodiments, the incubation temperature can be about 15° C. to about 28° C. (e.g., ambient). In some embodiments, incubating includes incubating the produce unit (e.g., underripe produce unit) in a sealed or semi-sealed volume.

In some embodiments, treating the climacteric produce unit (e.g., underripe climacteric produce unit) with ethylene includes treating the climacteric produce unit (e.g., underripe climacteric produce unit) with about 0.1 ppm ethylene to about 500 ppm (e.g., about 0.1 ppm to about 10 ppm, about 0.1 ppm to about 50 ppm, about 0.1 ppm to about 100 ppm, about 0.1 ppm to about 300 ppm, about 10 ppm to about 500 ppm, about 50 ppm to about 500 ppm, about 100 ppm to about 500 ppm, about 300 ppm to about 500 ppm, about 50 ppm to about 300 ppm, about 100 ppm to about 200 ppm, about 100 ppm to about 150 ppm, about 80 to about 120 ppm, about 0.2 to about 5 ppm, or about 1 to about 3 ppm) ethylene. In some embodiments, treating the climacteric produce unit (e.g., underripe climacteric produce unit) with ethylene includes treating the climacteric produce unit with ethylene for about 8 hours to about 6 days (e.g., about 8 hours to about 4 days, about 8 hours to about 2 days, about 8 hours to about 72 hours, about 8 hours to about 48 hours, about 8 hours to about 36 hours, about 8 hours to about 24 hours, about 8 hours to about 12 hours, about 4 days to about 6 days, about 2 days to about 6 days, about 72 hours to about 6 days, about 48 hours to about 6 days, about 36 hours to about 6 days, about 24 hours to about 6 days, or about 12 hours to about 6 days). In some embodiments, treating the climacteric produce unit (e.g., underripe climacteric produce unit) with ethylene comprises treating the climacteric produce unit with ethylene at a temperature of about 12° C. to about 25° C. (e.g., about 12° C. to about 15° C., about 12° C. to about 20° C., about 15° C. to about 25° C., about 15° C. to about 25° C., about 18° C. to about 20° C., or about 20° C. to about 22° C.). In some embodiments, treating the climacteric produce unit (e.g., underripe climacteric produce unit) with ethylene comprises treating the climacteric produce unit with ethylene at about 85% to about 100% relative humidity (e.g., about 85% to about 90%, about 85% to about 95%, about 90% to about 95%, about 90% to about 100%, or about 95% to about 100% relative humidity). In some embodiments, treating the climacteric produce unit (e.g., underripe climacteric produce unit) with ethylene comprises ethylene comprises treating the climacteric produce unit with ethylene for about 8 hours to about 96 hours (e.g., about 8 hours to about 12 hours, about 8 hours to about 24 hours, about 8 hours to about 48 hours, about 8 hours to about 72 hours, about 12 hours to about 96 hours, about 24 hours to about 96 hours, about 48 hours to about 96 hours, about 72 hours to about 96 hours, about 12 hours to about 24 hours, about 18 hours to about 24 hours, about 24 hours to about 48 hours). It will be understood that conditions appropriate to a particular type of produce unit may be readily available in relevant literature, such as through the Postharvest Center of the University of California (postharvest.ucdavis.edu/Commodity_Resources/Fact_Sheets/)

In some embodiments, treating the climacteric produce unit (e.g., underripe climacteric produce unit) (e.g., an avocado) with ethylene comprises treating the climacteric produce unit with about 100 to about 200 ppm ethylene at about 18° C. to about 20° C. and at least about 90% relative humidity (e.g., about 90% to about 100% relative humidity) for about 18 to about 24 hours.

In some embodiments, treating the climacteric produce unit (e.g., underripe climacteric produce unit) (e.g., a banana) with ethylene comprises treating the climacteric produce unit with about 50 to about 300 ppm ethylene at about 15° C. to about 20° C. and about 85% to about 100% relative humidity for about 8 to about 96 hours.

In some embodiments, treating the climacteric produce unit (e.g., underripe climacteric produce unit) (e.g., a mango) with ethylene comprises treating the climacteric produce unit with about 100 ppm ethylene at about 20° C. to about 22° C. and about 90% to about 95% relative humidity for about 12 to about 24 hours.

In any of the methods described herein, a treatment can be a chemical treatment, a physical treatment, or both. In some embodiments, a treatment is a chemical treatment but not a physical treatment. In some embodiments, a treatment is a physical treatment but not a chemical treatment. In some embodiments, a treatment is a chemical treatment and a physical treatment.

In some embodiments, chemical treatment includes an inhibitor of an ethylene receptor. In some embodiments, the inhibitor of the ethylene receptor can be selected from the group consisting of diazocyclopentadiene (DACP), cyclopropene (CP), 1-methylcyclopropene (1-MCP), 3,3-dimethylcyclopropene (3,3-DMCP), and a combination thereof. In some embodiments, the inhibitor of the ethylene receptor can be 1-MCP.

In any of the methods described herein, chemical treatment of slowing ripening and senescence can be applied in a number of ways. In some embodiments, the application can be done in the gas phase. For example, when the chemical treatment is an ethylene inhibitor (e.g., 1-MCP) a packet containing the ethylene inhibitor can be placed in a container (optionally with a release agent such as, for example, water) with the produce unit.

A chemical treatment can be applied at any appropriate temperature. In some embodiments, the temperature of the container and the surface temperature of the fruit is higher than the boiling point of the chemical treatment (e.g., ethylene inhibitor, such as for example 1-MCP). In some such embodiments, since the boiling point of the chemical treatment is lower than the temperature of the container and lower than the surface temperature of the produce unit, the chemical treatment can permeate the container and diffuse into the produce unit.

A chemical treatment can be applied using any appropriate method. For example, a chemical treatment (e.g., in liquid form) can be sprayed on the produce unit(s). In some embodiments, a chemical treatment in (e.g., in gas form) can be introduced to a volume (e.g., a sealed volume or semi-sealed volume) containing the produce units. In some embodiments, a chemical treatment may be provided in a stabilized form, for example, bound to a immobilization agent (e.g., a cyclodextrin) and subsequently released to come into contact with the produce unit(s). In some embodiments, release of the chemical treatment may be triggered/and or accelerated (e.g., via a temperature change). In some embodiments, release of the chemical treatment can include vaporization and/or sublimation of the chemical treatment.

It has been surprisingly found herein that application of a chemical treatment below the boiling point of the chemical treatment provides unexpectedly superior results. In some embodiments, the temperature of the container is higher than the boiling point of the chemical treatment, but the surface temperature of the produce unit is below the boiling point of the chemical treatment (e.g., ethylene inhibitor, such as for example 1-MCP). In some embodiments, the temperature of the container is held at a first temperature below the boiling point of the chemical treatment and subsequently raised to a second temperature above the boiling point of the chemical treatment. In some such embodiments, since the boiling point of the chemical treatment is lower than then the temperature of the container but higher than the surface temperature of the produce unit, the chemical treatment can permeate the container and at least partially liquify on the surface of the produce unit. The liquification of the chemical treatment can, in some embodiments, reduce the overall amount of the chemical treatment that diffuses into the fruit, and/or can allow the chemical treatment to diffuse into the fruit over a longer period of time. In some embodiments, the chemical treatment is an ethylene inhibitor such as 1-MCP. In some embodiments, the chemical treatment is delivered to the container with an immobilization agent (e.g., a cyclodextrin) such that it is stable or stabilized at temperatures below the boiling point, and subsequently released at temperatures above the boiling point.

Accordingly, also provided herein is a method of treating a produce unit (e.g., an underripe produce unit), the method including adding to an enclosed or semi-enclosed volume including an produce unit a chemical treatment, wherein the enclosed or semi-enclosed volume is at a temperature between about 4° C. and about 14° C. (e.g., about 4° C. to about 8° C.). Also provided herein is a method for modulating the ripening of a produce unit (e.g., an underripe produce unit), the method including a) adding to an enclosed or semi-enclosed volume including a produce unit a chemical treatment, wherein the enclosed or semi-enclosed volume is at a temperature between about 4° C. and about 14° C. (e.g., about 4° C. to about 8° C.), (b) determining that the produce unit should be ripened, shipped, or both, and (c) increasing the temperature of the enclosed or semi-enclosed volume to at least about 14° C.

A chemical treatment can be applied in any appropriate amount or concentration. In some embodiments, a produce unit (e.g., underripe produce unit) can be contained in a volume (in liters), and treating with the chemical treatment includes applying the chemical treatment in an amount of about 0.01 mg/liter volume to about 0.1 mg/liter volume (e.g., about 0.01 mg/liter volume to about 0.03 mg/liter volume, or about 0.02 mg/liter volume to about 0.07 mg/liter volume). In some embodiments, treating with the chemical treatment includes exposing the produce unit to the chemical treatment for a period of about 1 hour to about 24 hours (e.g., about 1 hour to about 3 hours, about 1 hour to about 6 hours, about 1 hour to about 12 hours about 1 hour to about 18 hours, about 3 hours to about 24 hours, about 6 hours to about 24 hours, about 12 hours to about 24 hours, about 18 hours to about 24 hours, about 6 hours to about 18 hours, or about 6 hours to about 12 hours). In some embodiments, treating with the chemical treatment includes exposing the produce unit (e.g., underripe produce unit) for about 8 hours.

For any of the methods described herein, the produce units can be transported while the treatment (e.g., physical treatment, chemical treatment, or a combination thereof) is applied. For example, a packet containing a chemical treatment (e.g., an ethylene inhibitor such as, for example, 1-MCP) could be placed in a container containing the produce units in or near a packing facility, and the container can then be loaded onto a vehicle and delivered to a grocer while the chemical treatment diffuses into the produce units. In some embodiments, the container can be held below the boiling point of the chemical treatment while in transport, and raised to a temperature above the boiling point prior to arrival at destination.

In any of the methods described herein, the produce unit(s) exposed to a chemical treatment can further be exposed to a physical treatment (e.g., a coating). The physical treatment can, for example, serve as a barrier to the diffusion of oxygen or water vapor into or out of the produce unit, thereby decreasing the rate of mass loss and/or oxidation of the produce unit. Furthermore, the physical treatment can, for example, serve as a barrier to gaseous molecules that modulate the ripening of the produce (e.g., ethylene, CO₂, among others). The physical treatment can be applied before harvesting the produce unit(s), after harvesting the produce unit(s) but before gassing the produce unit(s) with ethylene, after harvesting the produce unit(s) but before applying the chemical treatment, after gassing the produce unit(s) with ethylene but before applying the chemical treatment, or after applying the chemical treatment. The physical treatment can further extend the shelf life and/or ripe time of the produce unit(s).

The physical treatment (e.g., coatings) can, for example, be formed from a coating agent. The coating agent can be added to a solvent (e.g., water, ethylene, or a combination thereof) to form a mixture (e.g., a solution, a suspension, or an emulsion), the mixture can be applied to the surface of the produce unit(s), and the solvent can then be removed, e.g., by evaporation and/or forced convection, thereby forming a coating from the coating agent over the surface of the produce unit(s). Coating agents formed from or containing a high percentage of fatty acids and/or salts or esters thereof have in many cases been found to be effective at forming protective coatings over a variety of substrates, such that the coatings can prevent water loss from and/or oxidation of the substrate, and/or optionally serve as a barrier to gaseous molecules that modulate the ripening of the produce (e.g., ethylene, CO₂, among others). In some embodiments, the coatings may include mono/diglycerides and fatty acid salts.

In some embodiments, the physical treatment includes a monoglyceride and a fatty acid salt. In some embodiments, the monoglyceride can be present in the physical treatment in an amount of about 50% to about 99% (e.g., about 50% to about 60%, about 50% to about 70%, about 50% to about 80%, about 50% to about 90%, about 60% to about 99%, about 70% to about 99%, about 80% to about 99%, about 90% to about 99%, or about 95%) by mass. In some embodiments, the monoglyceride includes monoglycerides having carbon chain lengths longer than or equal to 10 carbons (e.g., longer than 11, longer than 12, longer than 14, longer than 16, longer than 18). In some embodiments, the monoglyceride includes monoglycerides having carbon chain lengths shorter than or equal to 20 carbons (e.g., shorter than 18, shorter than 16, shorter than 14, shorter than 12, shorter than 11, shorter than 10). In some embodiments, the monoglyceride includes a C16 monoglyceride, a C18 monoglyceride, a C10 monoglyceride, a C14 monoglyceride, or a combination thereof). In some embodiments, the monoglyceride includes a C16 monoglyceride and a C18 monoglyceride. In some embodiments, the fatty acid salt can be present in the physical treatment in an amount of about 1% to about 50% (e.g., about 1% to about 5%, about 1% to about 10%, about 1% to about 20%, about 1% to about 30%, about 1% to about 40%, about 5% to about 50%, about 10% to about 50%, about 20% to about 50%, about 30% to about 50%, about 40% to about 50%, or about 5%) by mass. In some embodiments, the fatty acid salt includes a C16 fatty acid salt, a C18 fatty acid salt, or a combination thereof. In some embodiments, the fatty acid salt includes a C16 fatty acid salt and a C18 fatty acid salt. In some embodiments, the physical treatment further comprises additives, including, but not limited to, cells, biological signaling molecules, vitamins, minerals, acids, bases, salts, pigments, aromas, enzymes, catalysts, antifungals, antimicrobials, time-released drugs, and the like, or a combination thereof.

In some embodiments, the physical treatment can be applied to the produce unit (e.g., underripe produce unit) in the form of a solution, suspension, or emulsion with a concentration of the physical treatment of about 0.1 g/L to about 100 g/L (e.g., about 0.1 to about 5 g/L, about 0.1 g/L to about 10 g/L, about 0.1 g/L to about 25 g/L, about 0.1 g/L to about 50 g/L, about 0.1 g/L to about 75 g/L, about 5 g/L to about 100 g/L, about 10 g/L to about 100 g/L, about 25 g/L to about 100 g/L, about 50 g/L to about 100 g/L, about 75 g/L to about 100 g/L, about 20 g/L to about 60 g/L, or about 30 g/L to about 50 g/L).

In some embodiments, the physical treatment includes a single coating. In some embodiments, the physical treatment includes multiple coatings. In some embodiments, the physical treatment includes 2, 3, 4, or 5 coatings.

Application of a treatment can cause the respiration rate of the produce unit to decrease by at least 10%, for example to decrease by at least about 10%, (e.g., at least 10%, at least 15%, at least 20%, at least 25%, at least 30%, at least 35%, at least 40%, at least 45%, at least 50%, at least 55%, at least 60%, at least 65%, at least 70%, at least 75%, at least 80%, at least 85%, at least 90%, at least 100%, at least 110%, at least 120%, at least 130%, at least 140%, or at least 150%, or more). For example, the respiration rate of the produce unit at least about 30 minutes (e.g., at least about 1 hour, about 3 hours, about 6 hours, about 9 hours, about 12 hours, or about 24 hours) after the application of the treatment(s) can be at least 10%, at least 15%, at least 20%, at least 25%, at least 30%, at least 35%, at least 40%, at least 45%, at least 50%, at least 55%, at least 60%, at least 65%, at least 70%, at least 75%, at least 80%, at least 85%, at least 90%, at least 100%, at least 110% at least 120%, at least 130%, at least 140%, or at least 150% less than respiration rate before the treatment. In some embodiments, the respiration rate of the produce unit at least about 30 minutes (e.g., about 30 minutes, about 1 hour, about 3 hours, about 6 hours, about 9 hours, about 12 hours, or about 24 hours) after the treatment is less than 0.9 times, less than 0.8 times, less than 0.7 times, less than 0.6 times, less than 0.5 times, less than 0.4 times, less than 0.3 times, less than 0.2 times, or less than 0.1 times the respiration rate before the treatment. In some embodiments, the respiration rate of the produce unit at least about 30 minutes (e.g., about 30 minutes, about 1 hour, about 3 hours, about 6 hours, about 9 hours, about 12 hours, or about 24 hours) after treatment can be reduced by at least about 10% (e.g., at least 10%, at least 15%, at least 20%, at least 25%, at least 30%, at least 35%, at least 40%, at least 45%, at least 50%, at least 55%, at least 60%, at least 65%, at least 70%, at least 75%, at least 80%, at least 85%, at least 90%, at least 100%, at least 110%, at least 120%, at least 130%, at least 140%, or at least 150%) compared to before the treatment, while allowing the produce unit to ripen without unintended quality issues (e.g., decay from biotic stressors such as mold, yeast, and/or bacteria, off flavors due to anaerobic respiration and/or deleterious modulation of endogenous enzymatic pathways, or physical defects, among others).

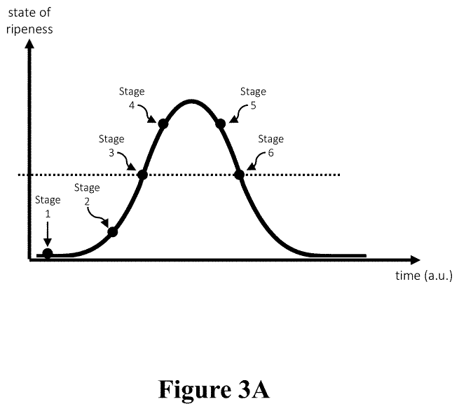

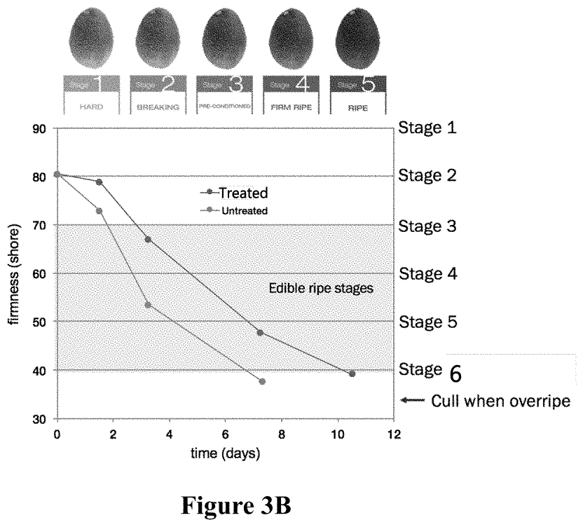

FIG. 3A is a qualitative plot indicating various stages of ripeness, which can generally be applied to produce. Stage 1 is hard and unripe. Stage 2 is when the produce begins to ripen. Stage 3 is when it crosses the threshold into ripe, stage 4 is just before peak ripe, stage 5 is just after peak ripe and stage 6 is when it is beyond ripe and is no longer good. In some embodiments, the produce units will be unripe at the time of harvest (i.e., at stage 1 or stage 2). In some embodiments, the produce will be ripe at the time of harvest (i.e., at stage 3, stage 4, or stage 5). In some embodiments, the produce units will be at an early stage of ripeness (e.g. between stage 3 and 4) at harvest. In some embodiments, the produce units will be at peak ripeness at the time of harvest (i.e., between stage 4 and stage 5). In some embodiments, the produce will be at a late stage of ripeness at the time of harvest (i.e., between stage 5 and stage 6). FIG. 3B represents these stages with avocados as an exemplary ripeness, either when treated with a chemical and/or physical treatment (green data) or not treated (gray data).

In some embodiments, a stage of a produce unit (e.g., an avocado) is based on firmness, and can be measured in shores (e.g., using a durometer) and/or pounds of pressure (e.g., using a penetrometer), then correlated to a stage. In some embodiments, a stage of a produce unit can be based on other parameters, such as respiration rate and/or color).

In view of the above, the methods described herein can, for example, increase the average time the produce units stay ripe and/or extend the shelf life of the produce units and/or delay spoilage of the produce units—for example, compared to produce units lacking a chemical treatment, a physical treatment, or both a chemical and a physical treatment. A produce unit can be harvested prior to, for example, determining a respiration rate or a stage, or before application of a chemical treatment, a physical treatment, or both.

In some embodiments, modulating the ripening of a produce unit (e.g., an underripe produce unit) includes extending a duration of time in which the produce unit is underripe. In some embodiments, modulating the ripening of the produce unit (e.g., underripe produce unit) includes increasing the total number of days that the produce unit (e.g., underripe produce unit) is in stage 1 or stage 2. In some embodiments, modulating the ripening of the produce unit (e.g., underripe produce unit) includes extending a duration of time that the produce unit (e.g., underripe produce unit) is acceptably ripe. In some embodiments, modulating the ripening of the produce unit (e.g., underripe produce unit) includes increasing the total number of days that the produce unit is in stage 3, stage 4, or stage 5. In some embodiments, modulating the ripening of the produce unit (e.g., underripe produce unit) includes extending a shelf life of the produce unit. In some embodiments, modulating the ripening of the produce unit (e.g., underripe produce unit) includes increasing the total number of days that the produce unit is in stage 1, stage 2, stage 3, stage 4, or stage 5. In some embodiments, modulating the ripening of the produce unit (e.g., underripe produce unit) includes delaying a senescent response, decreasing the intensity of a senescent response, or both. In some embodiments, the senescent response can be selected from the group consisting of a color change, softening, starch metabolism, mass loss, wrinkling, a fibrous appearance, and a combination thereof. In some embodiments, a color change includes browning, yellowing, blackening, or a combination thereof. In some embodiments, modulating the ripening of the produce unit (e.g., underripe produce unit) includes decreasing susceptibility of the produce unit (e.g., underripe produce unit) to a biological stressor associated with produce spoilage. In some embodiments, the biological stressor associated with produce spoilage can be selected from the group consisting of fungi, bacteria, and a combination thereof. In some embodiments, the fungi can be selected from the group consisting of mold, yeast, and a combination thereof.

In any of the methods described herein, the decrease in respiration rate caused by application of the treatment under the appropriate conditions can result in the shelf life and/or ripe time (e.g., the total time that the produce unit is in a state that a consumer would consider ripe) of the produce unit being increased (as compared to similar untreated units) by at least 5%, at least 10%, at least 15%, at least 20%, at least 30%, at least 40%, at least 50%, at least 60%, at least 70%, at least 80%, at least 90%, at least 100%, at least 120%, at least 140%, at least 160%, at least 180%, or at least 200%.

In some embodiments, the underripe produce unit can be an avocado. In some embodiments, modulating the ripening of the avocado includes increasing the total number of days that the avocado can be in stage 1 or stage 2. In some embodiments, modulating the ripening of the avocado includes increasing the total number of days that the avocado can be in stage 3, stage 4, or stage 5.

Also provided herein are produce units (e.g., treated produce units) including any of the treatments described herein. In some embodiments, the produce units display one or more properties as described herein, e.g., as compared to a similar produce unit lacking the treatment. For example, in some embodiments, the produce unit (e.g., underripe produce unit) has a greater duration of time in which the produce unit is underripe. In some embodiments, the produce unit (e.g., underripe produce unit) has an increase in the total number of days that the produce unit (e.g., underripe produce unit) is in stage 1 or stage 2. In some embodiments, the produce unit (e.g., underripe produce unit) has a greater duration of time that the produce unit is acceptably ripe. In some embodiments, the produce unit has in increase in the total number of days that the produce unit is in stage 3, stage 4, or stage 5. In some embodiments, the produce unit has an extended shelf life. In some embodiments, a produce unit has an increase in the total number of days that the produce unit is in stage 1, stage 2, stage 3, stage 4, or stage 5. In some embodiments, the produce unit has a delay in a senescent response, a decrease in the intensity of a senescent response, or both. In some embodiments, the senescent response can be selected from the group consisting of a color change, softening, starch metabolism, mass loss, wrinkling, a fibrous appearance, and a combination thereof. In some embodiments, a color change includes browning, yellowing, blackening, or a combination thereof. In some embodiments, the produce unit has a decreased susceptibility to a biological stressor associated with produce spoilage. In some embodiments, the biological stressor associated with produce spoilage can be selected from the group consisting of fungi, bacteria, and a combination thereof. In some embodiments, the fungi can be selected from the group consisting of mold, yeast, and a combination thereof.

In some embodiments, a produce unit can include a physical treatment and a chemical treatment. In some embodiments, a produce unit can include a physical treatment and not a chemical treatment. In some embodiments, a produce unit can include a chemical treatment and not a physical treatment.

Accordingly, in some embodiments, provided herein is a treated produce unit including a produce unit, and a chemical treatment, a physical treatment, or both, wherein the produce unit is in stage 3, stage 4, or stage 5 for at least 5 days.

In some embodiments, the produce unit is in stage 3, stage 4, or stage 5 for at least 7 days. In some embodiments, the produce unit is in stage 3, stage 4, or stage 5 for at least 10 days. In some embodiments, the produce unit is in stage 3, stage 4, or stage 5 for at least 14 days. In some embodiments, the produce unit is in stage 3, stage 4, or stage 5 for at least 18 days. In some embodiments, the produce unit is in stage 3, stage 4, or stage 5 for at least 21 days. In some embodiments, the produce unit is in stage 3, stage 4, or stage 5 for at least 30 days. In some embodiments, the produce unit is in stage 3, stage 4, or stage 5 for at least 2 months. In some embodiments, the produce unit is in stage 3, stage 4, or stage 5 for at least 3 months. In some embodiments, the produce unit is in stage 3, stage 4, or stage 5 for at least 4 months. In some embodiments, the produce unit is in stage 3, stage 4, or stage 5 for at least 5 months. In some embodiments, the produce unit is in stage 3, stage 4, or stage 5 for at least 6 months.

Also provided herein is a treated produce unit including a produce unit, a chemical treatment, and a physical treatment. In some embodiments, a mass loss rate of the treated produce unit can be lower (e.g., at least 5%, 10%, 15%, 20%, 30%, 40%, 50%, or more, lower) than a mass loss rate of a similarly treated produce unit including a chemical treatment but not a physical treatment.

In some embodiments, a treated produce unit including both a chemical treatment and a physical treatment can include a lower amount (e.g., 10%, 15%, 20%, 30%, 40%, 50%, or more, less) of the chemical treatment than if the chemical treatment were used alone. In some embodiments, a treated produce unit including both a chemical treatment and a physical treatment can include a lower amount (e.g., 10%, 15%, 20%, 30%, 40%, 50%, or more, less) of the physical treatment than if the physical treatment were used alone. In some such embodiments, the treated produce unit can have one or more similar properties (e.g., duration of time until ripe, duration of time acceptably ripe, and so forth) to a similar produce unit treated with a standard dose of a chemical treatment and a physical treatment. In some embodiments, the treated produce unit can have a superior flavor profile as compared to a similar produce unit treated with a standard dose of a chemical treatment. Without wishing to be bound by any particular theory, it is believed that when a lower dose of a chemical treatment is used, ethylene may be able to act on favor development pathways for positive flavor development.

The materials and methods of the disclosure will be further described in the following examples, which do not limit the scope of the methods and compositions of matter described in the claims.

### EXAMPLES

### Example 1

Analysis of Effectiveness of 1-MCP Exposure at Stage 1 to Reduce Respiration and Ripening Rate

Four groups of 180 (i.e., 3 sets of 60) Mexican avocados were analyzed over four days. One group received no 1-MCP, and the other group was exposed for eight hours to 1-MCP using 2, 4, or 6 packets of 1-MCP (immobilized in cyclodextrin at 0.014%) per set. Each packet was wetted with water, and then placed in a sealed 30 L container along with 1 set of 60 avocados. The avocados were left in the sealed container for 8 hr. After 8 hours, the avocados were removed and the respiration rate was measured over the course of 4 days. Additionally, the firmness of the avocados (represented as durometer stage) was measured using a durometer.

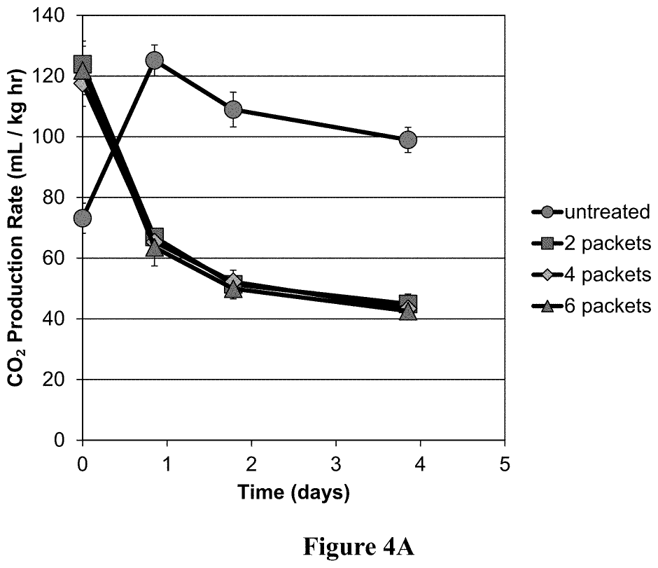

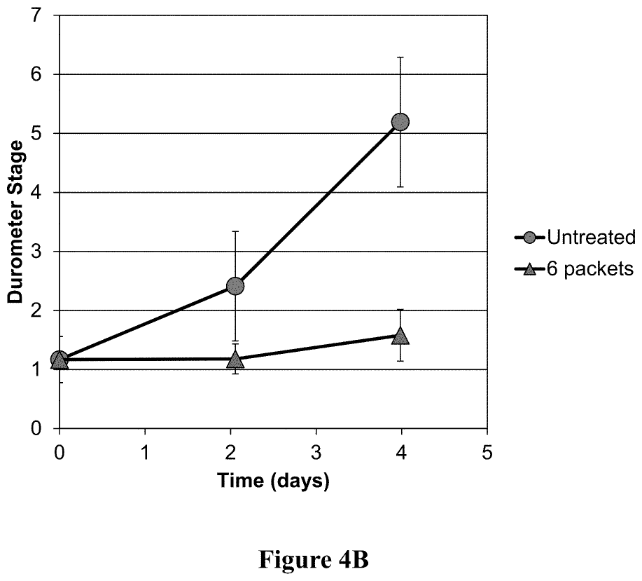

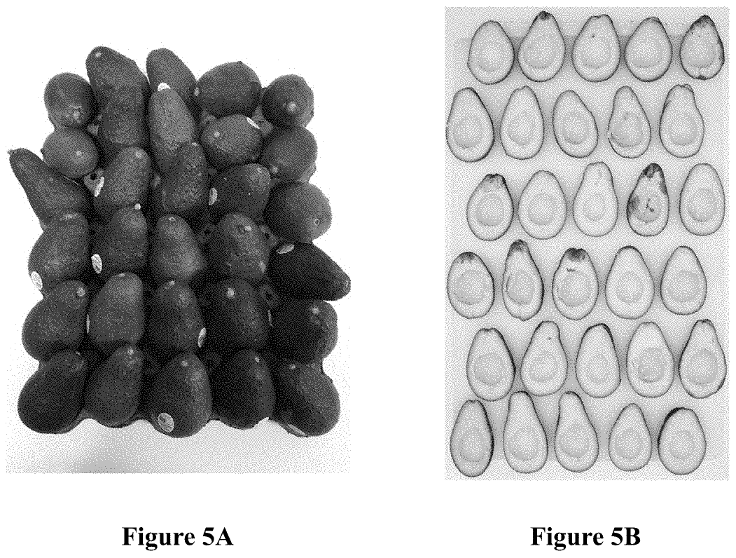

The respiration rate of 1-MCP avocados was high upon removal but quickly decreased and continued to decrease through 4 days post-exposure, and the data indicates that the use of 2 packets per set of avocados saturates all ethylene receptors with 1-MCP (FIG. 4A). The avocados treated with 6 packets of 1-MCP were stage 1.5 on day 4, while the untreated avocados were stage 5 (considered to be an edible ripeness) on day 4 (FIG. 4B). The delay in softening correlated with a reduction in respiration. Additionally, checkerboarding (high variability of stage of ripeness) of the avocados was observed (FIG. 5A), and the 1-MCP-treated avocados felt spongy. Once allowed to ripen (about two weeks), the 1-MCP avocados exhibited >25% incidence of mold and >30% incidence of flesh adhesion (FIG. 5B). Similar results were observed with the 2 and 4 packet groups (not pictured).

### Example 2

Analysis of the Effectiveness of 1-MCP Exposure at Stage 1 and 3 to Reduce Respiration and Ripening Rate

Three groups of 60 Mexican avocados were analyzed over three days at ambient temperature. One group received no treatment. One group of avocados at stage 1 (i.e., after day 0) was exposed to 1-MCP for approximately 8 hours. One group of avocados at stage 3 (i.e., after day 2) was exposed to 1-MCP for approximately 8 hours. The respiration rate of the avocados was measured over the course of 3 days.

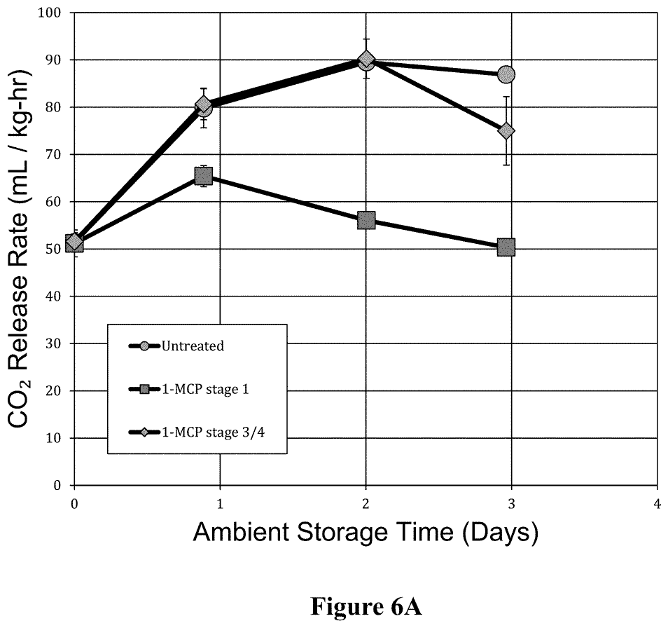

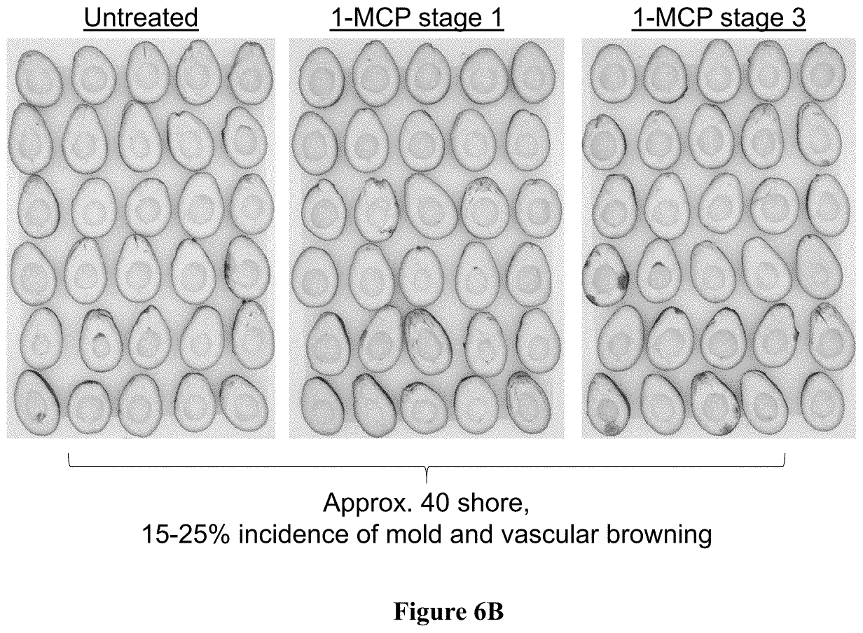

Avocados exposed to 1-MCP at either stage 1 or stage 3 displayed a decrease in respiration of about 15% to about 20%, and 1-MCP applied at stage 3 had a slight effect on the softening rate. 1-MCP exposure at stage 1 caused a continuous decrease in CO₂ production, back to day 0 levels (FIG. 6A). Exposure to 1-MCP did not improve internal quality. A 15-25% incidence of mold and vascular browning was observed (FIG. 6B).

### Example 3

Determination of the Effect of 1-MCP Exposure Temperature on the Ripening of MX Avocados

Three groups of 120 Mexican avocados were analyzed over about 5 days. One group received no treatment. One group was exposed to 1-MCP for 8 hours immediately after removal from cold storage at 4.5° C. (“cold 1-MCP”). One group was exposed to 1-MCP for 8 hours after the avocados spent 2 hours at ambient temperature (“semi-cold 1-MCP”). One group was exposed to 1-MCP for 8 hours after the avocados spent 6 hours at ambient temperature (“ambient 1-MCP”). The respiration rate of the avocados was measured over the course of 5 days. The firmness of the avocados was measured using a durometer.

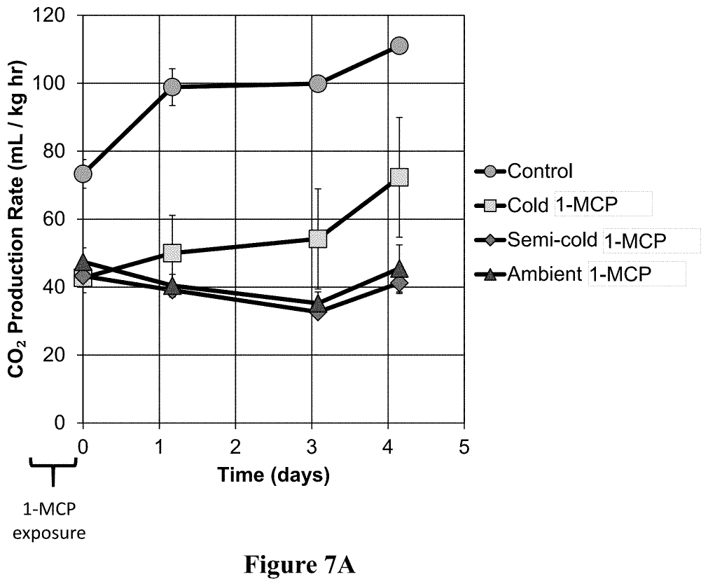

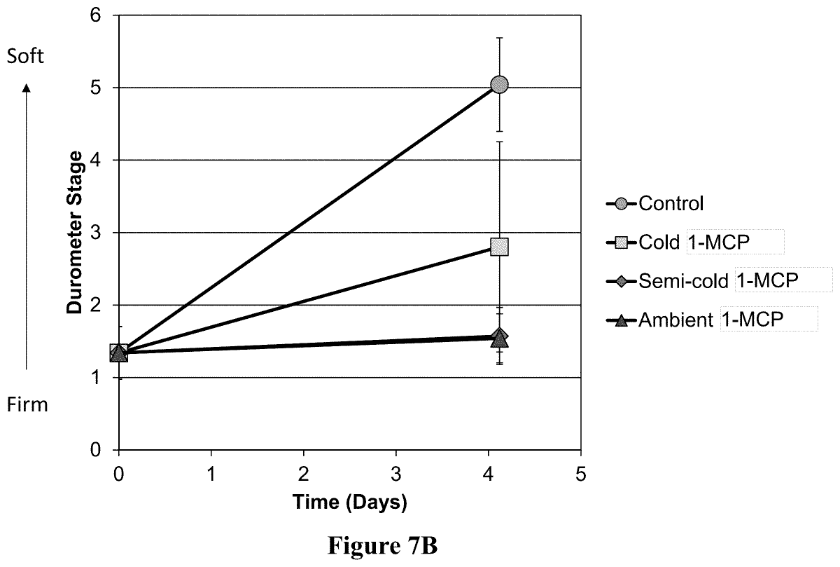

The semi-cold and ambient 1-MCP exposure yielded a greater respiration reduction than cold 1-MCP (the cumulative respiration factors (RF) of 2.5× vs. 1.8× for cold) (FIG. 7A). Given that the 1-MCP boiling point is 12° C., without wishing to be bound to theory, with the avocado surface at or near 4.5° C., the 1-MCP could be liquifying on the produce surface, evaporating as produce comes to ambient and binding to some but not all ethylene receptors, or providing a more controlled dose of 1-MCP to the produce.

The cold 1-MCP group was still over two stages behind the control group (and more checkerboarded) by the time the control group reached stage 5, however ripening behavior was still observed. The semi-cold and ambient 1-MCP yielded a greater softening rate reduction than cold 1-MCP (FIG. 7B), but the produce did not ripen effectively.

### Example 4

Examination of Impact of Overtreatment on California Avocados

Three groups of 120 Californian avocados were analyzed. One group received no treatment. One group was treated with a single layer of physical treatment B (by bowl dipping and ambient drying; physical treatment B at 40 g/L, with 2 g/L glycerol monocaprate). One group was treated with three layers of physical treatment (by bowl dipping and ambient drying; physical treatment B at 40 g/L, with 2 g/L glycerol monocaprate). The respiration rate of the avocados was measured over 2 days.

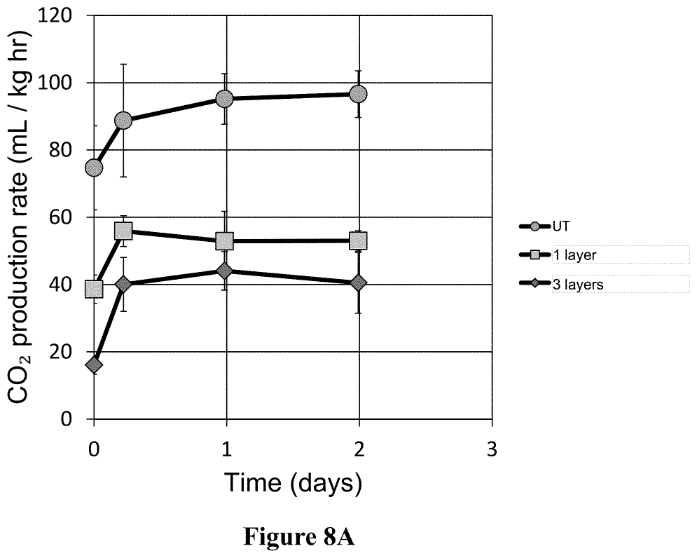

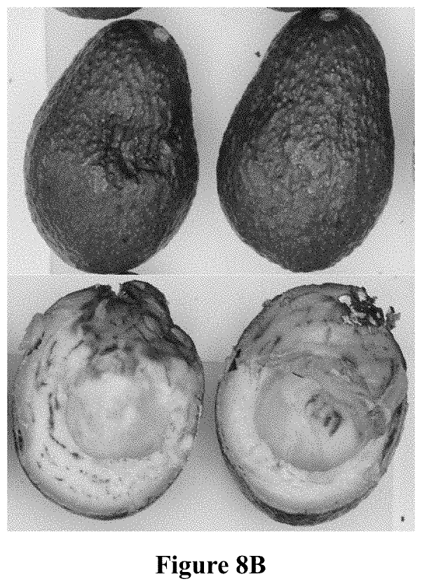

The respiration rates remained low for both the one-layer and the three-layer groups throughout the study, with RFs of 1.76 and 2.29, respectively (FIG. 8A), however the 3 layer group exhibited significant quality defects. Low respiration rates throughout the ripening process can yield very poor quality avocados; sunken patches, extreme ripening delay, and/or severe mold can be observed (FIG. 8B).

### Example 5

Respiratory Peak Analysis

Four groups of Mexican avocados were analyzed in order to investigate the minimum respiration peak that Mexican avocadoes should reach in order to ripen without quality issues. One group received no treatment. One group was treated with 1 layer of physical treatment (by bowl dipping and ambient drying; physical treatment A at 30 g/L with 3 g/L glycerol monocaprate). One group was treated with 2 layers of physical treatment (by bowl dipping and ambient drying; physical treatment A at 30 g/L with 3 g/L glycerol monocaprate). One group was treated with 3 layers of physical treatment (by bowl dipping and ambient drying; physical treatment A at 30 g/with 3 g/L glycerol monocaprate). The respiration rate of the avocados was measured daily for three weeks. Correlation of peak CO₂ production rate to ripening outcome was performed for each avocado for each week.

Respiration factors varied week-to-week (Table 1), and accordingly, the proportion of avocados that did and did not ripen properly vary week-to-week.

TABLE 1
Respiration factors over three weeks of protocol replication

| Layers | Week 1 | Week 2 | Week 3 |
|---|---|---|---|
| 1 layer | 1.64 | 1.32 | 1.39 |
| 2 layers | 2.00 | 1.43 | 2.11 |
| 3 layers | 2.98 | 1.81 | 2.41 |

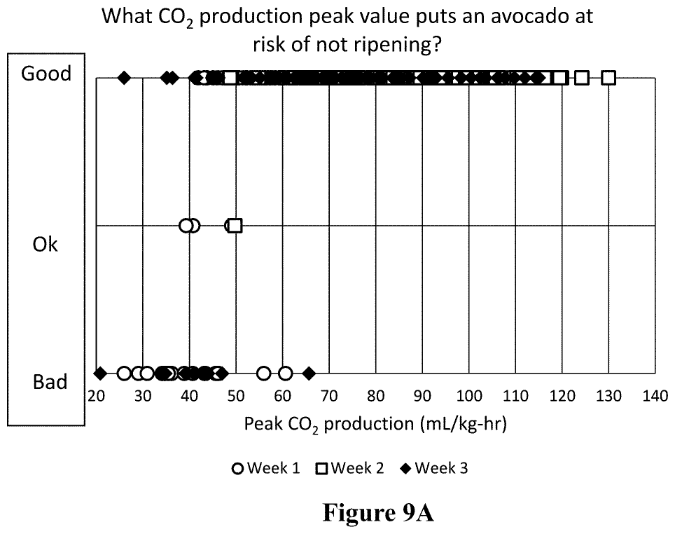

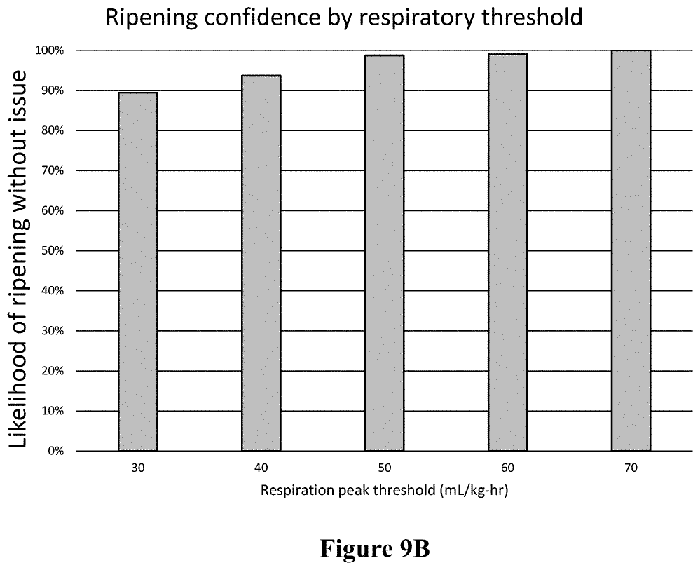

Mexican avocados that had a respiration peak at or about 50 mL/kg*hr had a 98.7% chance of ripening properly (FIG. 9A), while Mexican avocados that had a respiration peak at or about 30 mL/kg*hr had about a 90% chance of ripening properly (FIG. 9B).

### Example 6

Ripened Fruit Concentration Study

To determine the difference in performance for treating avocados on a brush bed at varying concentrations before or after they have been put in ripening rooms, four flats of Mexican avocados were analyzed. One flat received no treatment. The other three flats were treated with physical treatment A at 12, 22, and 32 g/L, respectively, applied using brush bed system and subsequently dried at 50° C. Avocados treated with physical treatment A were also triggered with ethylene, either before or after treatment with physical treatment A. The respiration rate of the avocados was measured. The firmness of the avocados was measured using a durometer.

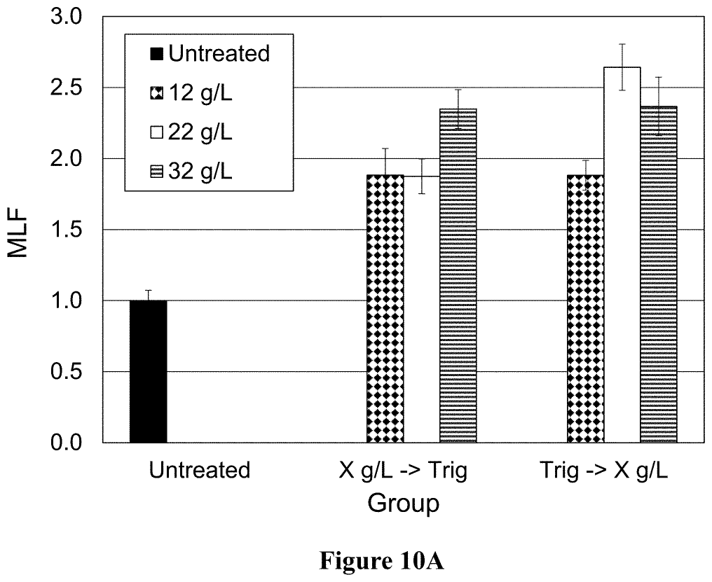

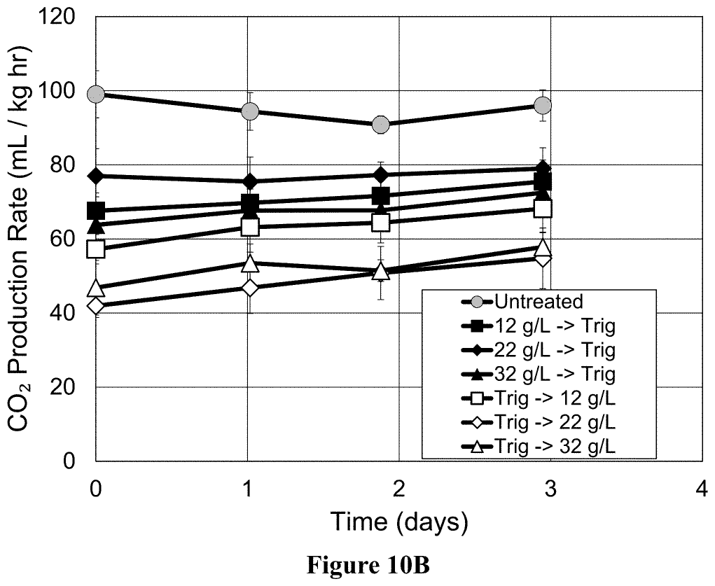

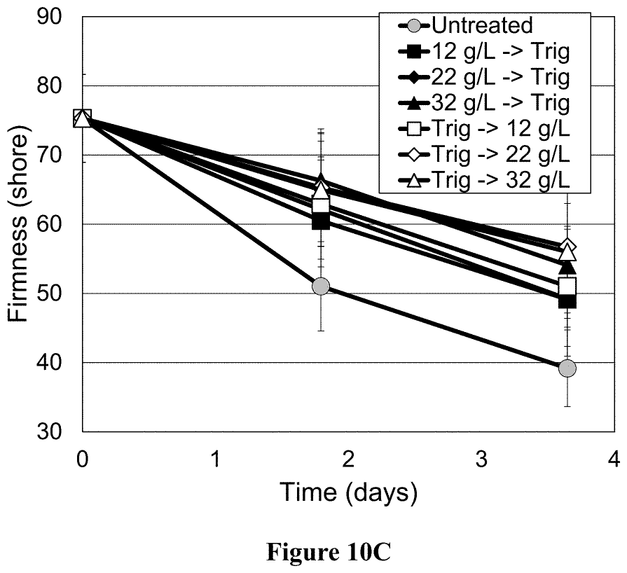

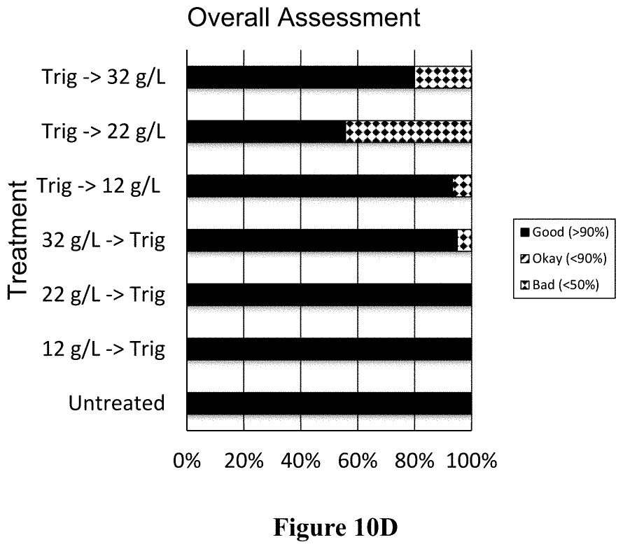

While there was not a clear trend in mass loss performance with increasing concentration for both the triggered (“Trig”) before and triggered after group (FIG. 10A), there was a general trend of decreased CO₂ production with increasing concentration. Additionally, triggering the avocados before treating yielded a greater respiration reduction than the corresponding groups that were triggered before (FIG. 10B). A one stage difference for all of the treatments at 12 g/L as well as 22 g/L->Trig, as well as a two stage difference for the other conditions compared to the untreated group was observed (FIG. 10C). Corresponding to the larger decrease in respiration rate, triggering the avocados before treating also led to a reduction in overall quality, with the major observed quality defect being sunken patches (FIG. 10D).

### Example 7

Analysis of the Effect of Ethylene Exposure after 1-MCP Exposure on the Ripening Rate of Mexican Avocados

Three groups of 180 Mexican avocados were analyzed. One group received no treatment. One group was treated with 1-MCP for 8 hours. One group was treated with 1-MCP for 8 hours, followed by treatment with ethylene for 24 hours at 200 ppm.

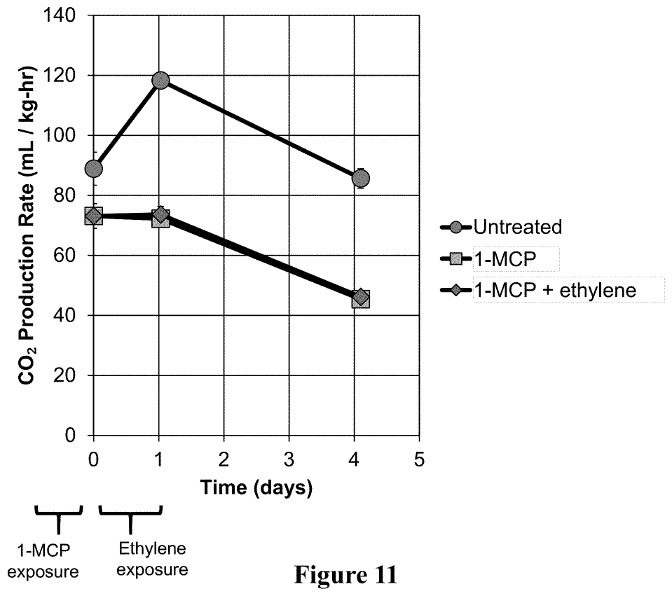

The 1-MCP treated groups exhibited the same respiration rate regardless of ethylene exposure and a 1.62× RF, indicating that all ethylene receptors were blocked by 1-MCP, and that the avocados did not produce more ethylene receptors as they ripened (FIG. 11). Accordingly, ethylene exposure is not necessarily an effective way to overcome the ripening delay from 1-MCP.

### Example 8

Comparative Performance of the Use of a Chemical Treatment, a Physical Treatment, or a Combination Thereof on Cucumbers

Cucumbers were analyzed in the presence (2 ppm) and absence (0 ppm) of exogenous ethylene at 20° C. for 5 days. Four groups of cucumbers were analyzed. One group received no treatment. One group was treated with a chemical treatment (i.e., 1-MCP). One group was treated with a physical treatment A (40 g/L). One group was treated with both a chemical treatment (i.e., 1-MCP) and physical treatment A (40 g/L). The respiration rate and the mass loss rate of the cucumbers was measured

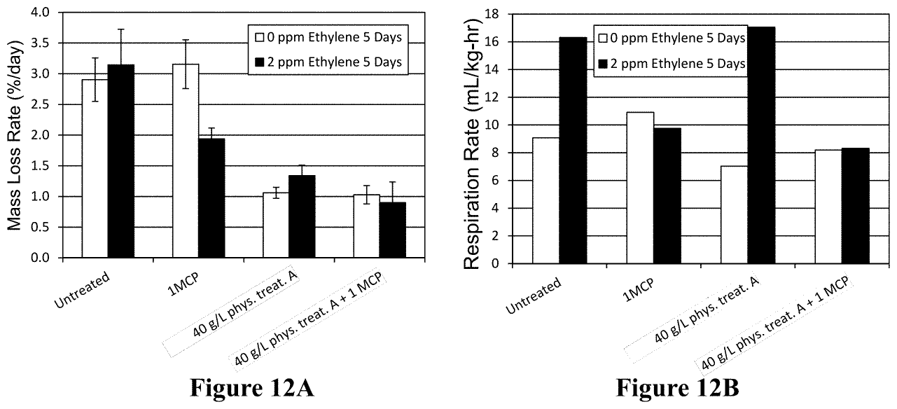

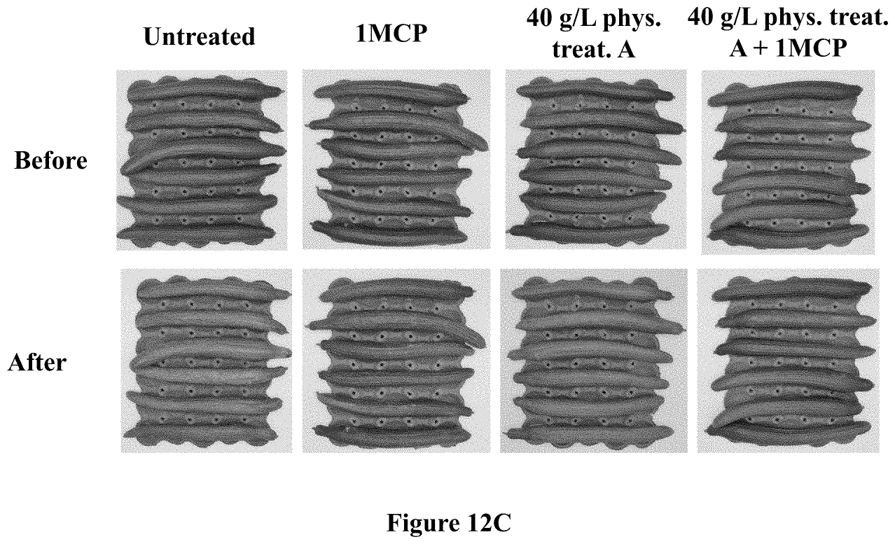

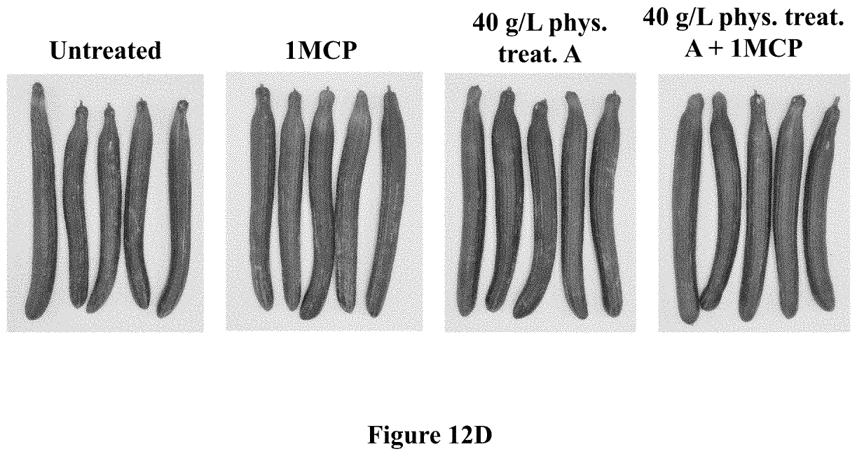

With respect to mass loss, 1-MCP lowered the mass loss rate of the cucumbers in the presence of ethylene, but had no impact on mass loss rate in the absence of ethylene. Treating the cucumbers with a physical treatment lowered the mass loss rate by approximately 3 times in both the presence and absence of ethylene. Treating the cucumbers with both a physical and a chemical treatment also reduced the mass loss rate by approximately 3 times both in the presence and absence of ethylene (FIG. 12A).

With respect to respiration, the untreated cucumber increased in respiration in the presence of ethylene by approximately 1.8 times. The treatment of cucumbers with 1-MCP mitigated the corresponding increase in respiration rate, but did not lower the overall respiration rate as compared to the untreated group in the absence of ethylene. In contrast, the treatment of cucumbers with a physical treatment did lower the respiration rate of the cucumbers in the absence of ethylene, but did not mitigate the corresponding increase in respiration when exposed to ethylene. The combination of the chemical and physical treatments provided both a reduction in respiration (as compared to the 1-MCP group), and the protection from ethylene exposure (FIG. 12B).

With respect to the aesthetics of the cucumber, exposure to ethylene induced a yellowing in the untreated group. The treatment of cucumbers with both a chemical and a physical treatment reduced the yellowing of the cucumber, although the chemical treatment had a greater positive impact on the rate of yellowing. Only the groups treated with a physical treatment had an impact on the shrivel of the cucumbers, and the combination of a chemical and a physical treatment showed the greatest reduction in both yellowing and shrivel (FIG. 12C). In the absence of ethylene, no significant yellowing of any of the treatment groups was observed, and the cucumbers treated with the physical treatment showed a reduction in shrivel (FIG. 12D).

Cucumbers with both a chemical (i.e., 1-MCP) and a physical treatment reduced the mass loss, decreased the yellowing, and protected against ethylene induced senescence to the greatest extent.

### Example 9

Comparative Performance of the Use of a Chemical Treatment, a Physical Treatment, or a Combination Thereof on Persian Limes

Persian limes were analyzed in the presence (2 ppm) and absence (0 ppm) of exogenous ethylene at 20° C. for 5 days. Four groups of limes were analyzed. One group received no treatment. One group was treated with 1-MCP. One group was treated with physical treatment A (40 g/L). One group was treated with both 1-MCP and physical treatment A (40 g/L). The respiration rate of the limes was measured. The mass loss rate of the limes was measured.

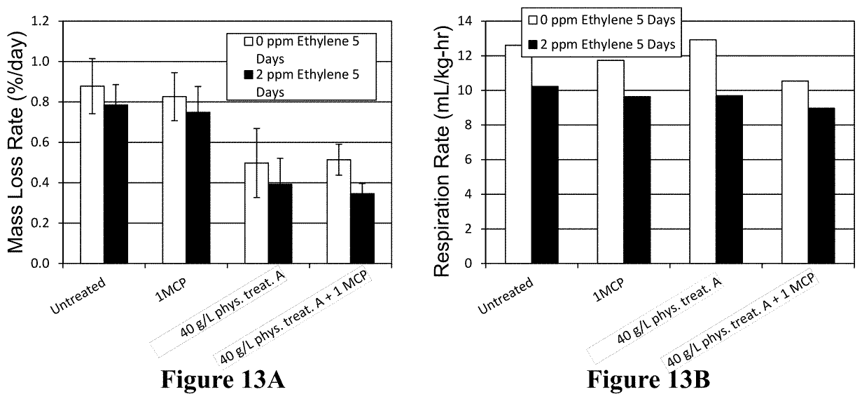

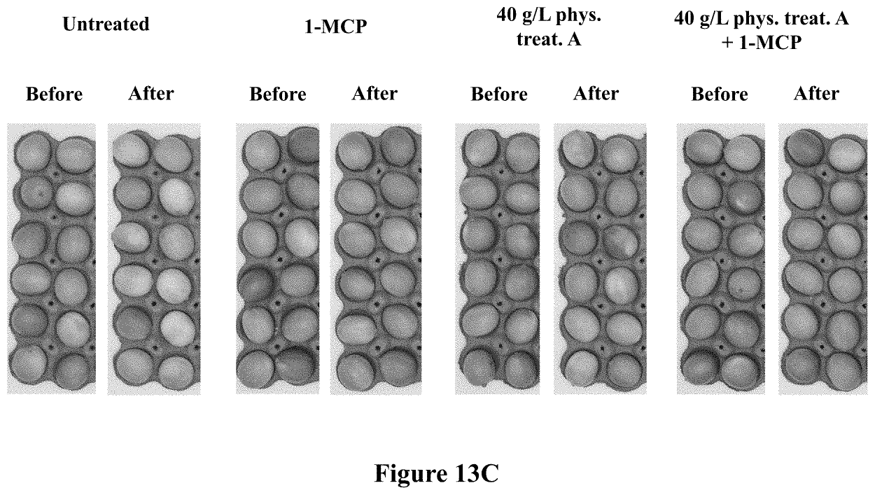

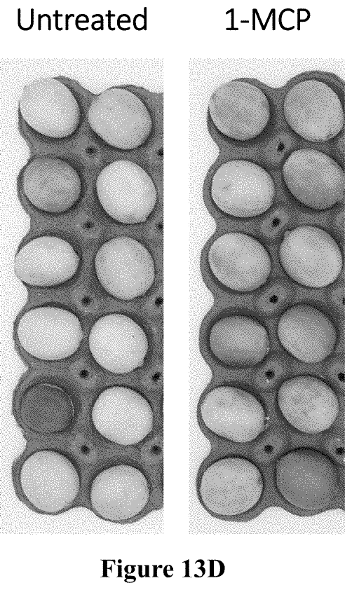

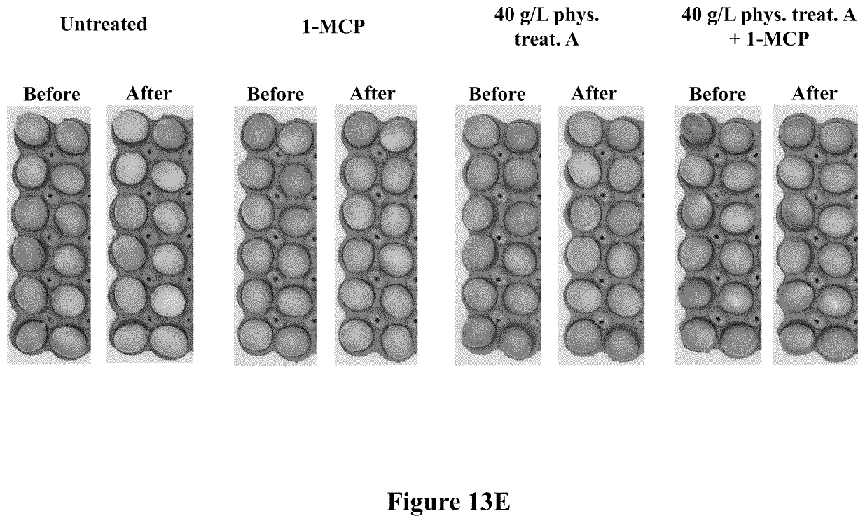

With respect to mass loss, 1-MCP had no significant impact on the mass loss rate of the Persian limes when not exposed to ethylene, nor in the presence of 2 ppm ethylene. In contrast, treating the Persian limes with physical treatment reduced the mass loss rate by approximately 1.8-2 times, both in the absence and presence of ethylene. There was no significant additional impact on mass loss observed by treating the Persian limes with both 1-MCP and a physical treatment (FIG. 13A).

With respect to respiration, there was no substantial impact on respiration for any of the treatment groups, although a small reduction in respiration rate of 1-2 mL CO₂/kg-hr was noted in the treatment group with both 1-MCP and a physical treatment (FIG. 13B).

With respect to the aesthetics of the Persian limes, all three treatment groups reduced the rate of yellowing of the limes over a 5 day period. The 1-MCP and the physical treatment both reduced the yellowing of the limes, but the physical treatment provided an additional aesthetic benefit by reducing the observable impact of mass loss on the lime. The combination of both 1-MCP and the physical treatment had the greatest impact on the aesthetics of the limes (FIG. 13C). An example of the impact of 1-MCP on the yellowing rate after 14 days can be seen in FIG. 13D. The same aesthetic trends were observed with groups that were exposed to 2 ppm ethylene, as ethylene did not appear to impact the aesthetics of the limes (FIG. 13E).

Additional embodiments described in this disclosure are described below.

Embodiment 1 is a method for modulating the ripening of an underripe produce unit at a temperature comprising:
treating the underripe produce unit, wherein:
   the underripe produce unit has a first respiration rate and a second respiration rate,
   the first respiration rate has been determined at a first time and the second respiration rate has been determined at a second time, wherein the first time and the second time are different,
   the first respiration rate and the second respiration rate are determined at the temperature,
   the second respiration rate is at least about 10% greater than the first respiration rate at the temperature; and
treating the underripe produce unit comprises a chemical treatment, a physical treatment, or both.

Embodiment 2 is the method of embodiment 1, wherein modulating the ripening of the underripe produce unit comprises extending a length of time before the underripe produce unit ripens.

Embodiment 3 is the method of embodiments 1 or 2, wherein modulating the ripening of the underripe produce unit comprises extending a total number of days that the produce unit is in:
stage 1 and stage 2,
stage 3, stage 4, and stage 5, or
stage 1, stage 2, stage 3, stage 4, and stage 5,
relative to a total number of days that an untreated produce unit is in these respective stages, wherein:
   a produce unit in stage 1 is hard and unripe,
   a produce unit in stage 2 is beginning to ripen,
   a produce unit in stage 3 is crossing the threshold into ripe,
   a produce unit in stage 4 is just before peak ripe, and
   a produce unit in stage 5 is just after peak ripe.

Embodiment 4 is the method of embodiments 1 through 3, wherein the physical treatment comprises forming a coating on the underripe produce unit.

Embodiment 5 is the method of embodiment 4, wherein the coating comprises a monoglyceride.

Embodiment 6 is the method of embodiment 5, wherein the coating further comprises a fatty acid salt.

Embodiment 7 is the method of embodiments 1 through 6, wherein the physical treatment further comprises contacting the underripe produce unit with a cell, a biological signaling molecule, a vitamin, a mineral, a pigment, an aroma, an enzyme, a catalyst, an antifungal, an antimicrobial, a time-released drug, or a combination thereof.

Embodiment 8 is the method of embodiments 1 through 7, wherein the chemical treatment comprises contacting the underripe produce with an inhibitor of an ethylene receptor, wherein the inhibitor of the ethylene receptor comprises one or more of diazocyclopentadiene (DACP), cyclopropene (CP), 1-methylcyclopropene (1-MCP), 3,3-dimethylcyclopropene (3,3-DMCP), or a combination thereof.

Embodiment 9 is the method of embodiments 1 through 9, wherein modulating the ripening of the underripe produce unit comprises delaying a senescent response, decreasing the intensity of a senescent response, or both, wherein the senescent response comprises a color change, softening, starch metabolism, mass loss, wrinkling, a fibrous appearance, and a combination thereof, and the color change comprises browning, yellowing, blackening, or a combination thereof.

Embodiment 10 is the method of embodiments 1 through 9, wherein modulating the ripening of the underripe produce unit comprises decreasing susceptibility of the underripe produce unit to a biological stressor associated with produce spoilage, wherein the biological stressor comprises fungi, bacteria, or a combination thereof, and the fungi comprises mold, yeast, or a combination thereof.

Embodiment 11 is the method of embodiments 1 through 10, wherein the underripe produce unit is a climacteric produce unit, and the climacteric produce unit comprises an apple, an apricot, an avocado, a banana, a blueberry, a bayberry, a custard apple, a fig, a guava, a kiwifruit, a lychee, a mamey sapote, a mango, a melon, a mountain papaya, a nectarine, a papaya, a peach, a pear, a persimmon, a plum, or a tomato.

Embodiment 12 is the method of embodiments 1 through 11, wherein the underripe produce unit is a non-climacteric produce unit, and the non-climacteric produce unit comprises a cherry, a clementine mandarin, a cucumber, a grape, a grapefruit, a lime, an orange, a pepper, a pineapple, a strawberry, or a watermelon.

Embodiment 13 is the method of embodiments 1 through 12, further comprising:
determining, at a second time, a second respiration rate of the underripe climacteric produce unit at the temperature, wherein a first respiration rate of the underripe climacteric produce unit at the temperature has been determined at a first time, and the first time and the second time are different; and
if the second respiration rate is at least about 10% greater than the first respiration rate, treating the underripe climacteric produce unit with a chemical treatment, a physical treatment, or both; or
if the second respiration rate is less than 10% greater than the first respiration rate,
   incubating the underripe produce unit at an incubation temperature until the respiration rate is at least about 10% greater than first respiration rate, and subsequently treating the underripe climacteric produce unit with a chemical treatment, a physical treatment, or both, or
   treating the underripe climacteric produce unit with ethylene until the respiration rate is at least about 10% greater than the first respiration rate, and subsequently treating the underripe climacteric produce unit with a chemical treatment and not a physical treatment, or a physical treatment and not a chemical treatment.

Embodiment 14 is the method of embodiment 13, wherein the incubation temperature is within about 10% of the temperature.

Embodiment 15 is the method of embodiments 13 or 14, wherein the incubation temperature is in a range of about 4° C. to about 28° C.

Embodiment 16 is the method of any of embodiments 13 through 15, wherein the first respiration rate was determined at least 24 hours after the underripe produce unit was harvested, less than 3 weeks after the underripe produce unit was harvested, or both.

Embodiment 17 is the method of embodiments 13 through 16, wherein determining the second respiration rate is performed at least 48 hours after the first respiration rate was determined, less than 3 weeks after the first respiration rate was determined, or both.

Embodiment 18 is the method of embodiments 13 through 17, further comprising, prior to determining the second respiration rate, determining the first respiration rate.

Embodiment 19 is a method for modulating the ripening of an underripe produce unit at a temperature, the method comprising:
determining, at a first time, a first respiration rate for the underripe produce unit at the temperature;
determining, at a second time, a second respiration rate for the underripe produce unit at the temperature, wherein the second respiration rate is at least about 10% greater than the first respiration rate, and the first time and the second time are different, and
treating the underripe produce unit with a chemical treatment, a physical treatment, or

Embodiment 20 is a method for modulating the ripening of an underripe produce unit, the method comprising:
adding to an enclosed or semi-enclosed volume comprising an underripe produce unit a chemical treatment, wherein the enclosed or semi-enclosed volume is at a temperature between about 4° C. and about 14° C.;
determining whether the underripe produce unit should be ripened, shipped, or both; and
increasing the temperature of the enclosed or semi-enclosed volume to at least about or greater than 14° C.

Embodiment 21 is a treated produce unit comprising:
a produce unit,
wherein the produce unit has been treated with a chemical treatment, a physical treatment, or both, and the treatment extends a total number of days the produce unit is in stage 3, stage 4, and stage 5 for at least 5 days, relative to the total number of days that an untreated produce unit is in these respective stages, wherein:
   a produce unit in stage 1 is hard and unripe,
   a produce unit in stage 2 is beginning to ripen,
   a produce unit in stage 3 is crossing the threshold into ripe,
   a produce unit in stage 4 is just before peak ripe, and
   a produce unit in stage 5 is just after peak ripe.

Embodiment 22 is the produce unit of embodiment 21, wherein the treatment extends a total number of days the produce unit is in stage 1 and stage 2 by at least 5 days, relative to the total number of days that the untreated produce unit is in these respective stages.

Embodiment 23 is a treated produce unit comprising:

a produce unit;
wherein the produce unit has been treated with a chemical treatment, a physical treatment, or both, and the treatment extends a firmness of the produce unit as measured in shores or pounds of pressure in each of stage 1, stage 2, stage 3, stage 4, and stage 5 by at least one day or at least two days, relative to the total number of days that an untreated produce unit is in these respective stages, wherein:
   a produce unit in stage 1 is hard and unripe,
   a produce unit in stage 2 is beginning to ripen,
   a produce unit in stage 3 is crossing the threshold into ripe,
   a produce unit in stage 4 is just before peak ripe, and
   a produce unit in stage 5 is just after peak ripe.

Embodiment 24 is the treated produce unit of claim 24, wherein the produce unit is an avocado.

Although this disclosure contains many specific embodiment details, these should not be construed as limitations on the scope of the subject matter or on the scope of what may be claimed, but rather as descriptions of features that may be specific to particular embodiments. Certain features that are described in this disclosure in the context of separate embodiments can also be implemented, in combination, in a single embodiment. Conversely, various features that are described in the context of a single embodiment can also be implemented in multiple embodiments, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular embodiments of the subject matter have been described. Other embodiments, alterations, and permutations of the described embodiments are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results.

Accordingly, the previously described example embodiments do not define or constrain this disclosure. Other changes, substitutions, and alterations are also possible without departing from the spirit and scope of this disclosure.

What is claimed is:

1. A method for modulating the ripening of an underripe produce unit at a temperature, the method comprising:
treating the underripe produce unit, wherein:
the underripe produce unit has a first respiration rate and a second respiration rate,
the first respiration rate has been determined at a first time and the second respiration rate has been determined at a second time, wherein the first time and the second time are different,
the first respiration rate and the second respiration rate are determined at the temperature,
the second respiration rate is at least about 10% greater than the first respiration rate at the temperature; and
treating the underripe produce unit comprises a chemical treatment, a physical treatment, or both.

2. The method of claim 1, wherein modulating the ripening of the underripe produce unit comprises extending a length of time before the underripe produce unit ripens.

3. The method of claim 1, wherein modulating the ripening of the underripe produce unit comprises extending a total number of days that the produce unit is in:
stage 1 and stage 2,
stage 3, stage 4, and stage 5, or
stage 1, stage 2, stage 3, stage 4, and stage 5,
relative to a total number of days that an untreated produce unit is in these respective stages, wherein:
a produce unit in stage 1 is hard and unripe,
a produce unit in stage 2 is beginning to ripen,
a produce unit in stage 3 is crossing the threshold into ripe,
a produce unit in stage 4 is just before peak ripe, and
a produce unit in stage 5 is just after peak ripe.

4. The method of claim 1, wherein the physical treatment comprises forming a coating on the underripe produce unit.

5. The method of claim 4, wherein the coating comprises a monoglyceride.

6. The method of claim 5, wherein the coating further comprises a fatty acid salt.

7. The method of claim 1, wherein the physical treatment further comprises contacting the underripe produce unit with a cell, a biological signaling molecule, a vitamin, a mineral, a pigment, an aroma, an enzyme, a catalyst, an antifungal, an antimicrobial, a time-released drug, or a combination thereof.

8. The method of claim 1, wherein the chemical treatment comprises contacting the underripe produce with an inhibitor of an ethylene receptor, wherein the inhibitor of the ethylene receptor comprises one or more of diazocyclopentadiene (DACP), cyclopropene (CP), 1-methylcyclopropene (1-MCP), 3,3-dimethylcyclopropene (3,3-DMCP), or a combination thereof.

9. The method of claim 1, wherein modulating the ripening of the underripe produce unit comprises delaying a senescent response, decreasing the intensity of a senescent response, or both, wherein the senescent response comprises a color change, softening, starch metabolism, mass loss, wrinkling, a fibrous appearance, and a combination thereof, and the color change comprises browning, yellowing, blackening, or a combination thereof.

10. The method of claim 1, wherein modulating the ripening of the underripe produce unit comprises decreasing susceptibility of the underripe produce unit to a biological stressor associated with produce spoilage, wherein the biological stressor comprises fungi, bacteria, or a combination thereof, and the fungi comprises mold, yeast, or a combination thereof.

11. The method of claim 1, wherein the underripe produce unit is a climacteric produce unit, and the climacteric produce unit comprises an apple, an apricot, an avocado, a banana, a blueberry, a bayberry, a custard apple, a fig, a guava, a kiwifruit, a lychee, a mamey sapote, a mango, a melon, a mountain papaya, a nectarine, a papaya, a peach, a pear, a persimmon, a plum, or a tomato.

12. The method of claim 1, wherein the underripe produce unit is a non-climacteric produce unit, and the non-climacteric produce unit comprises a cherry, a clementine mandarin, a cucumber, a grape, a grapefruit, a lime, an orange, a pepper, a pineapple, a strawberry, or a watermelon.

13. The method of claim 1, further comprising:
determining, at a second time, a second respiration rate of the underripe climacteric produce unit at the temperature, wherein a first respiration rate of the underripe climacteric produce unit at the temperature has been determined at a first time, and the first time and the second time are different; and
if the second respiration rate is at least about 10% greater than the first respiration rate, treating the underripe climacteric produce unit with a chemical treatment, a physical treatment, or both; or
if the second respiration rate is less than 10% greater than the first respiration rate,
incubating the underripe produce unit at an incubation temperature until the respiration rate is at least about 10% greater than first respiration rate, and subsequently treating the underripe climacteric produce unit with a chemical treatment, a physical treatment, or both, or
treating the underripe climacteric produce unit with ethylene until the respiration rate is at least about 10% greater than the first respiration rate, and subsequently treating the underripe climacteric produce unit with a chemical treatment and not a physical treatment, or a physical treatment and not a chemical treatment.

14. The method of claim 13, wherein the incubation temperature is within about 10% of the temperature.

15. The method of claim 13, wherein the incubation temperature is in a range of about 4° C. to about 28° C.

16. The method of claim 13, wherein the first respiration rate was determined at least 24 hours after the underripe produce unit was harvested, less than 3 weeks after the underripe produce unit was harvested, or both.

17. The method of claim 13, wherein determining the second respiration rate is performed at least 48 hours after the first respiration rate was determined, less than 3 weeks after the first respiration rate was determined, or both.

18. The method of claim 13, further comprising, prior to determining the second respiration rate, determining the first respiration rate.

19. A method for modulating the ripening of an underripe produce unit at a temperature, the method comprising:
determining, at a first time, a first respiration rate for the underripe produce unit at the temperature;
determining, at a second time, a second respiration rate for the underripe produce unit at the temperature, wherein the second respiration rate is at least about 10% greater than the first respiration rate, and the first time and the second time are different, and
treating the underripe produce unit with a chemical treatment, a physical treatment, or both.

20. A method for modulating the ripening of an underripe produce unit, the method comprising:
adding to an enclosed or semi-enclosed volume comprising an underripe produce unit a chemical treatment, wherein the enclosed or semi-enclosed volume is at a temperature between about 4° C. and about 14° C.;
determining whether the underripe produce unit should be ripened, shipped, or both; and
increasing the temperature of the enclosed or semi-enclosed volume to at least about or greater than 14° C.

21. A treated produce unit comprising:
a produce unit,
wherein the produce unit has been treated with a chemical treatment, a physical treatment, or both, and the treatment extends a total number of days the produce unit is in stage 3, stage 4, and stage 5 for at least 5 days, relative to the total number of days that an untreated produce unit is in these respective stages, wherein:
a produce unit in stage 1 is hard and unripe,
a produce unit in stage 2 is beginning to ripen,
a produce unit in stage 3 is crossing the threshold into ripe,
a produce unit in stage 4 is just before peak ripe, and
a produce unit in stage 5 is just after peak ripe.

22. The treated produce unit of claim 21, wherein the treatment extends a total number of days the produce unit is in stage 1 and stage 2 by at least 5 days, relative to the total number of days that the untreated produce unit is in these respective stages.

23. A treated produce unit comprising:
a produce unit;
wherein the produce unit has been treated with a chemical treatment, a physical treatment, or both, and the treatment extends a firmness of the produce unit as measured in shores or pounds of pressure in each of stage 1, stage 2, stage 3, stage 4, and stage 5 by at least one day or at least two days, relative to the total number of days that an untreated produce unit is in these respective stages, wherein:
a produce unit in stage 1 is hard and unripe,
a produce unit in stage 2 is beginning to ripen,
a produce unit in stage 3 is crossing the threshold into ripe,
a produce unit in stage 4 is just before peak ripe, and
a produce unit in stage 5 is just after peak ripe.

24. The treated produce unit of claim 23, wherein the produce unit is an avocado.
